(19) United States
(12) Patent Application Publication
(10) Pub. No.: US 2024/0246800 A1
(43) Pub. Date: Jul. 25, 2024

(54) LIFTING DEVICE

(71) Applicant: MILWAUKEE ELECTRIC TOOL CORPORATION, Brookfield, WI (US)

(72) Inventors: Garrett P. Mitchell, Milwaukee, WI (US); Evan M. Glanzer, Milwaukee, WI (US); Joseph W. Miller, Waukesha, WI (US); Allison M. Neuser, Wauwatosa, WI (US); Will Didier, Cedarburg, WI (US); Alicia G. Rothenberg, Milwaukee, WI (US); Beau A. Harrier, Brown Deer, WI (US); Daryl S. Richards, Sussex, WI (US)

(21) Appl. No.: 18/421,507

(22) Filed: Jan. 24, 2024

Related U.S. Application Data
(60) Provisional application No. 63/588,933, filed on Oct. 9, 2023.
(60) Provisional application No. 63/506,277, filed on Jun. 5, 2023.
(60) Provisional application No. 63/481,249, filed on Jan. 24, 2023.

(51) Int. Cl. B66F 9/20; B66F 9/08

(52) U.S. Cl. CPC B66F 9/20; B66F 9/08

(57) ABSTRACT

A lifting device includes a base, a mast coupled to the base, a carriage coupled to the mast, and a lifting assembly configured to move the mast and carriage in a first direction to a desired elevation relative to the base. The lifting device also includes an electric motor, a battery pack for providing electrical power to the electric motor and a first spool with a first cable to alternately raise and lower the carriage in the first direction. The lifting device further includes an auxiliary drive unit including a second spool with a second cable to raise and lower the lifting device in a second direction different than the first direction.

### CROSS-REFERENCE TO RELATED APPLICATIONS

This application claims priority to U.S. Provisional Patent Application No. 63/588,933, filed on Oct. 9, 2023, U.S. Provisional Patent Application No. 63/506,277, filed on Jun. 5, 2023, and U.S. Provisional Patent Application No. 63/481,249, filed on Jan. 24, 2023, the entire contents of all of which are incorporated herein by reference.

### FIELD OF INVENTION

The present invention generally relates to lifting devices.

### BACKGROUND OF THE INVENTION

Current lifting devices make it difficult for a single operator to lift material from the ground and install the material at a desired height and location. During the process, current lifting devices cause strain to the operator during loading of material onto the lifting device, during manual adjustment (e.g., cranking) of the material to the desired height, and during unloading of the material at the desired height. Further, some lifting devices require two or more operators are required to lift the material to the desired height.

### SUMMARY OF THE INVENTION

The present invention provides, in one aspect, a lifting device including a base, a mast coupled to the base, a carriage coupled to the mast, and a lifting assembly configured to move the mast and carriage in a first direction to a desired elevation relative to the base. The lifting device includes an electric motor, a battery pack for providing electrical power to the electric motor and a first spool with a first cable to alternately raise and lower the carriage in the first direction. The lifting device includes an auxiliary drive unit including a second spool with a second cable to raise and lower the lifting device in a second direction different than the first direction.

The present invention provides, in another aspect, a lifting system including a lifting device including a base, a mast coupled to the base, a carriage coupled to the mast, and a lifting assembly configured to move the mast and carriage in a first direction to a desired elevation relative to the base. The lifting device includes an electric motor, and a battery pack for providing electrical power to the electric motor. The lifting device includes a remote control unit wirelessly coupled to the lifting device to alternately raise and lower the carriage in the first direction via a wireless connection.

The present invention provides, in another aspect, a lifting device including a base, a mast coupled to the base, a carriage coupled to the mast, and a lifting assembly configured to move the mast and carriage in a first direction to a desired elevation relative to the base. The lifting device includes an electric motor, a battery pack for providing electrical power to the electric motor and a spool with a cable to alternately raise and lower the carriage in the first direction. The lifting device includes means for detecting a weight and/or a center of gravity of a load to be lifted by the lifting device, and a user interface operable to communicate information about the weight and/or the center of gravity of the load to a user of the lifting device.

The present invention provides, in another aspect, a lifting device including a base, a mast coupled to the base, a carriage coupled to the mast, and a lifting assembly configured to move the mast and carriage in a first direction to a desired elevation relative to the base. The lifting device includes an electric motor, a battery pack for providing electrical power to the electric motor and a spool with a cable to alternately raise and lower the carriage in the first direction. The lifting device includes means for detecting a voltage of the battery pack, and a user interface operable to communicate a low-voltage state of the battery to a user of the lifting device.

The present invention provides, in another aspect, a lifting device including a base, a mast coupled to the base, a carriage coupled to the mast, and a lifting assembly configured to move the mast and carriage in a first direction to a desired elevation relative to the base. The lifting device includes an electric motor, a battery pack for providing electrical power to the electric motor and a spool with a cable to alternately raise and lower the carriage in the first direction. The lifting device includes means for detecting a number of lifts performed by the lifting device, a user interface operable to communicate information about the number of lifts performed by the lifting device to a user of the lifting device, and means for alerting the user of the lifting device when the lifting device exceeds a predetermined number of lifts performed by the lifting device.

The present invention provides, in another aspect, a lifting device including a base, a mast coupled to the base, a cam and latch mechanism configured to adjust the mast between a locked state and an unlocked state, a carriage coupled to the third mast portion, and a lifting assembly configured to move the mast and the carriage in a first direction to a desired elevation relative to the base. The lifting assembly includes an electric motor, a battery pack for providing electrical power to the electric motor, and a spool with a cable to alternately raise and lower the carriage in the first direction.

Other aspects of the invention will become apparent by consideration of the detailed description and accompanying drawings.

### BRIEF DESCRIPTION OF THE DRAWINGS

FIG. 1 is a perspective view of a lifting device.

FIG. 2 is a perspective view of a portion of the lifting device.

FIG. 3 is a perspective view of a lifting assembly for the lifting device.

FIG. 4 is a schematic view of the lifting device of FIG. 1 further including a power takeoff mechanism.

FIG. 5 is a schematic view of the power takeoff mechanism of FIG. 4.

FIG. 6 is a perspective view of a remote control unit for the lifting device according to an embodiment of the invention.

FIG. 7 is the lifting device of FIG. 1 further including one or more sensors.

FIG. 8 is a schematic view of a lifting system according to an embodiment of the invention.

FIG. 9 is a schematic view of a lifting system according to another embodiment of the invention.

FIG. 10 is a schematic view of a lifting system according to another embodiment of the invention.

FIG. 11 is a schematic view of a lifting system according to another embodiment of the invention.

FIG. 12 is a perspective view of a lifting device according to another embodiment of the invention.

FIG. 13 is a perspective view of a portion of the lifting device of FIG. 12.

FIG. 14 is a perspective view of a lifting device according to another embodiment of the invention.

FIG. 15 is a perspective view of the lifting device of FIG. 14.

FIG. 16 is a portion of the lifting device of FIG. 1.

FIG. 17 is a cradle for use with the lifting device of FIG. 1.

FIG. 18 is a boom for use with the lifting device of FIG. 1.

FIG. 19 is a pan for use with the lifting device of FIG. 1.

FIG. 20 is a portion of the lifting device of FIG. 1.

FIG. 21 is a pad for use with the lifting device of FIG. 1.

FIG. 22 is a portion of the lifting device of FIG. 1.

FIG. 23 is a roller platform for use with the lifting device of FIG. 1.

FIG. 24 is a brake mechanism for use with the lifting device of FIG. 1.

FIG. 25 is a control system for the lifting device of FIG. 1, according to embodiments described herein.

FIG. 26 is a wireless communication controller for the lifting device of FIG. 1, according to embodiments described herein.

FIG. 27 is a communication network for the lifting device of FIG. 1, according to embodiments described herein.

FIG. 28 is an interface for controlling the lifting device of FIG. 1, according to embodiments described herein.

FIG. 29 is an interface for controlling the lifting device of FIG. 1, according to embodiments described herein.

FIG. 30 is an interface for controlling the lifting device of FIG. 1, according to embodiments described herein.

FIG. 31 is an arming button for the lifting device of FIG. 1, according to embodiments described herein.

FIG. 32 is an arming button for the lifting device of FIG. 1, according to embodiments described herein.

FIG. 33 is the arming button of FIG. 31 disposed near a handle of the lifting device of FIG. 1, according to embodiments described herein.

FIG. 34 is the arming button of FIG. 31 disposed near a handle of the lifting device of FIG. 1, according to embodiments described herein.

FIG. 35 is the arming button of FIG. 32 disposed on a user interface of the lifting device of FIG. 1, according to embodiments described herein.

FIG. 36 is the arming button of FIG. 32 disposed on a user interface of the lifting device of FIG. 1, according to embodiments described herein.

FIG. 37 is a perspective cross-sectional view of a cam and lever mechanism for a mast of the lifting assembly of FIG. 1 through line 37-37 of FIG. 1.

FIG. 38 is a front cross-sectional view of the cam and lever mechanism of FIG. 37.

FIG. 39 is a front cross-sectional view of the cam and lever mechanism of FIG. 37, illustrating extension of the mast.

FIG. 40 is a front cross-sectional view of the cam and lever mechanism of FIG. 37, illustrating continued extension of the mast.

FIG. 41 is a front cross-sectional view of the cam and lever mechanism of FIG. 37, illustrating continued extension of the mast.

FIG. 42 is a front cross-sectional view of the cam and lever mechanism of FIG. 37, illustrating retraction of the mast.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

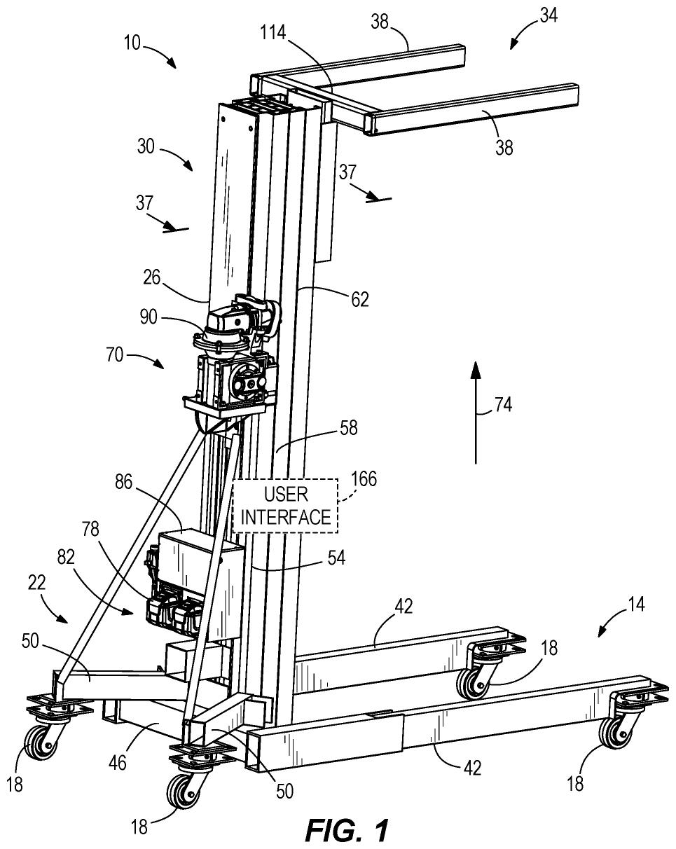

FIG. 1 illustrates a lifting device 10 that is able to rigidly (e.g., lift from below) lift materials (e.g., pipes, weights, loads, etc.) and move the material to a desired height and location (e.g., an installation height). The lifting device 10 includes a base 14 having a plurality of wheels 18, a support structure 22 having a first end coupled to the base 14 and a second end coupled to a back plate 26, a mast 30 extending from the base 14, and a carriage 34 coupled to the mast 30. The carriage 34 includes parallel first and second arms 38 that extend from the mast 30.

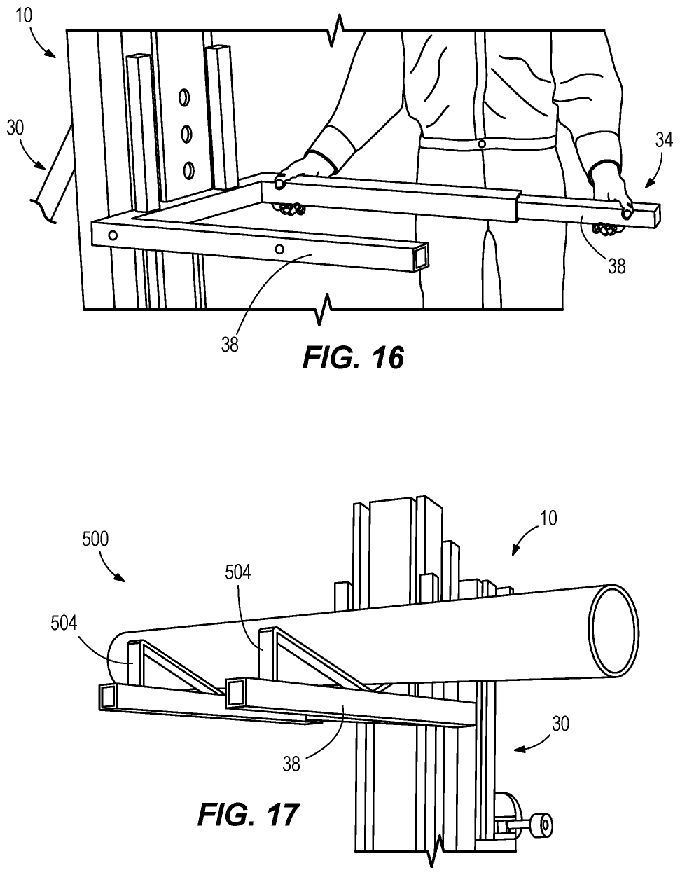

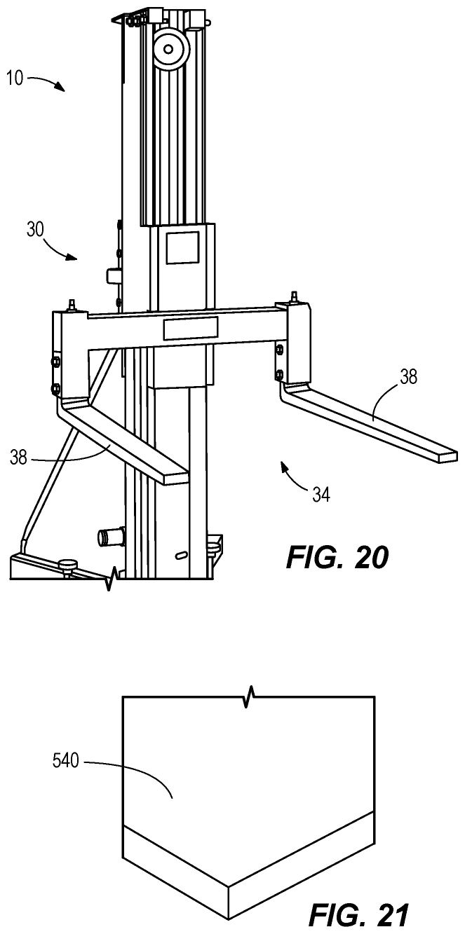

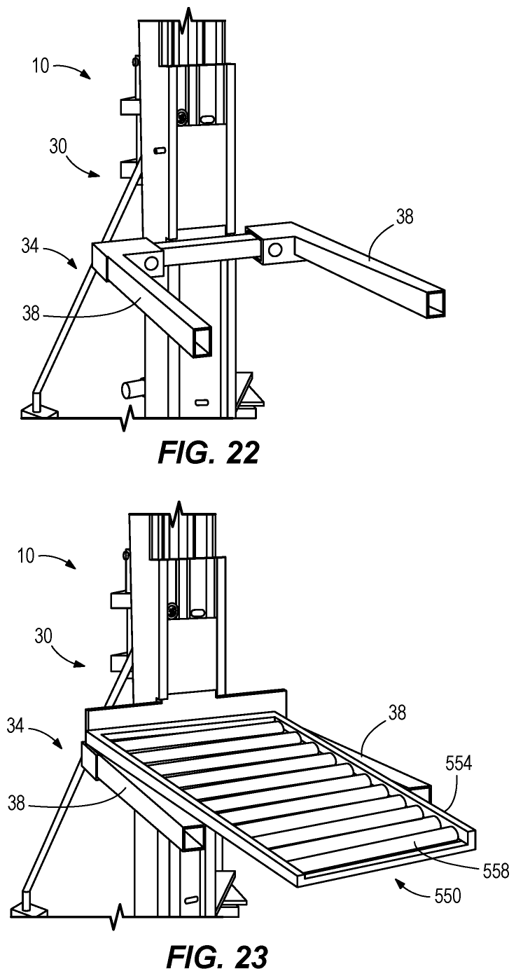

In some embodiments, as illustrated in FIG. 16, the first and second arms 38 are extendable and move relative to the mast 30. In other embodiments, as illustrated in FIG. 20, the first and second arms 38 include a flat top surface or may include flat forks configured to lift materials and move the material to the desired height and location. Still, in other embodiments, as illustrated in FIG. 22, the first and second arms 38 are adjustable such that the arms 38 are adjustable relative to the mast 30 in a first direction (e.g., increase or decrease a length of the arms 38) and a second direction (e.g., increase or decrease a spacing between the arms 38).

In the illustrated embodiment, the base 14 includes parallel first and second base rails 42 that extend from each end of a cross-beam 46, and an additional two frame rails 50 that obliquely extend from the cross-beam 46. The wheels 18 are coupled to a distal end of each of the rails 42, 50. As a result, wheels 18 are positioned in each corner of the base 14. In some embodiments, the first and second base rails 42 may pivot relative to the cross-beam 46 to facilitate movement and storage of the lifting device 10. In some embodiments still, the first and second base rails 42 may extend away (e.g., telescoping) from the cross-beam 46 to accommodate different material weights supported by the lifting device 10.

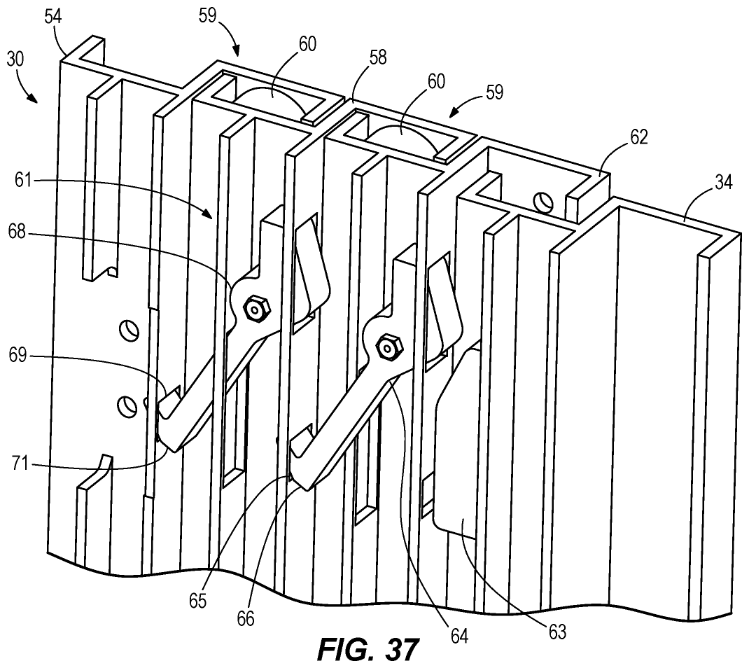

With continued reference to FIG. 1, the mast 30 includes a first (stationary) mast portion 54 that is rigidly coupled to the backplate 26 and the cross-beam 46, and second and third (movable) mast portions 58, 62 that are coupled to and movable relative to the first mast portion 54. In other embodiments, more or fewer mast portions may be used. In the illustrated embodiment, each mast portion 54, 58, 62 of the mast 30 includes a telescoping structure that engages with a corresponding mast portion such that the mast 30 and the carriage 34 are movable between a plurality of positions. For example, the telescoping structures may be tracks 59 formed between the first, second, and third mast portions 54, 58, 62 respectively (FIG. 37). The tracks 59 may receive rollers 60 that allow movement of the second and third mast portions 58, 62 respectively relative to the first mast portion 54 and each other.

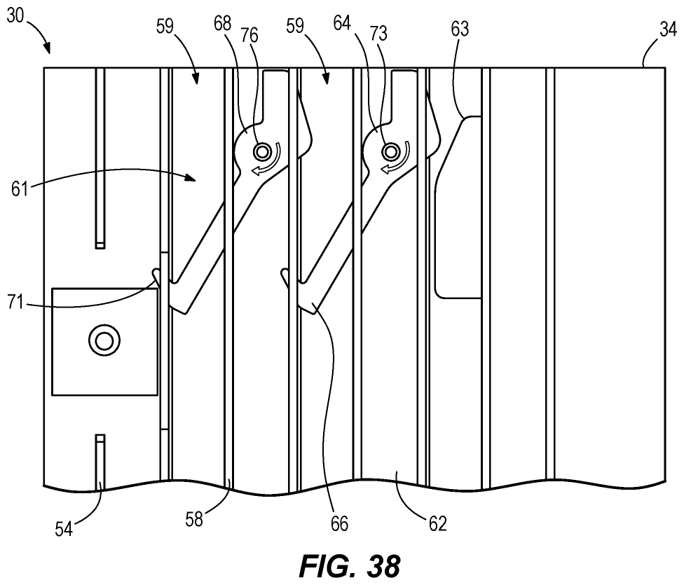

Moving ahead in the drawings, FIG. 37 illustrates a cam and lever mechanism 61 positioned in the mast 30. The cam and lever mechanism 61 is configured to adjust the mast 30 between a locked state and an unlocked state. The cam and lever mechanism 61 includes a first cam 63 and a first latch 64. The first cam 63 is positioned in the carriage 34 and the first latch 64 is positioned in the third mast portion 62. The second mast portion 58 defines a first aperture 65 configured to receive the first latch 64. The first latch 64 includes an angled surface or end 66 that is received by the first aperture 65. The first latch 64 includes a spring 73 (e.g., a torsion spring) biasing the first latch 64 in a clockwise direction toward the second mast portion 58 (FIG. 38).

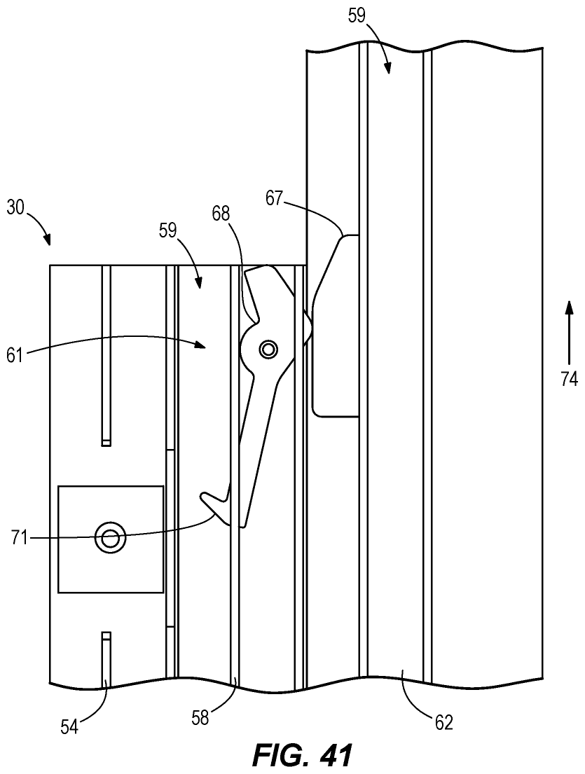

With reference to FIGS. 37 and 41, the cam and lever mechanism 61 further includes a second cam 67 and a second latch 68. The second cam 67 is positioned in the third mast portion 62 and the second latch 68 is positioned in the second mast portion 58. The first mast portion 54 defines a second aperture 69 configured to receive the second latch 68. The second latch 68 includes an angled surface or end 71 that is received by the second aperture 69. The second latch 68 includes a spring 76 (e.g., a torsion spring) biasing the second latch 68 in a clockwise direction toward the first mast portion 54 (FIG. 38).

In operation, when the mast 30 is not extended relative to the base 14, the cam and lever mechanism 61 is in the locked state (FIG. 38). In the locked state, the first latch 64 is engaged with the first aperture 65 and the second latch 68 is engaged with the second aperture 69 to lock the second and third mast portions 58, 62 respectively relative to the first mast portion 54. The second and third mast portions 58, 62 respectively are not movable relative to the first mast portion 54 in the locked state.

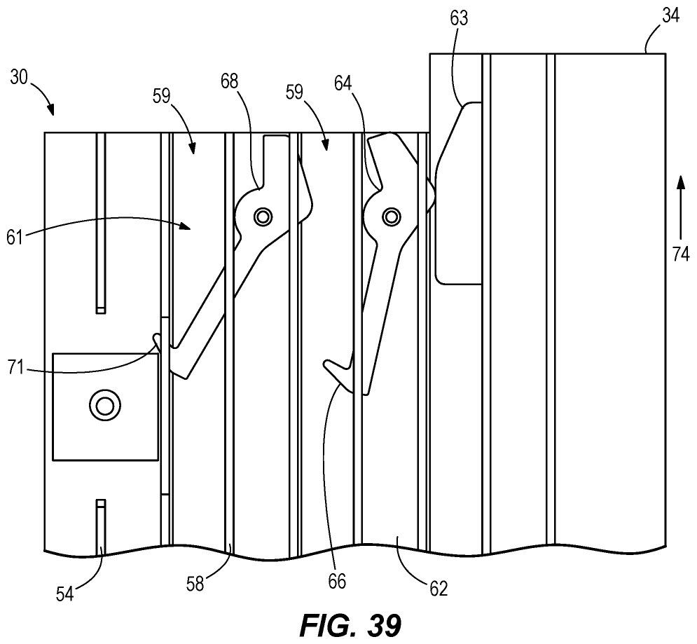

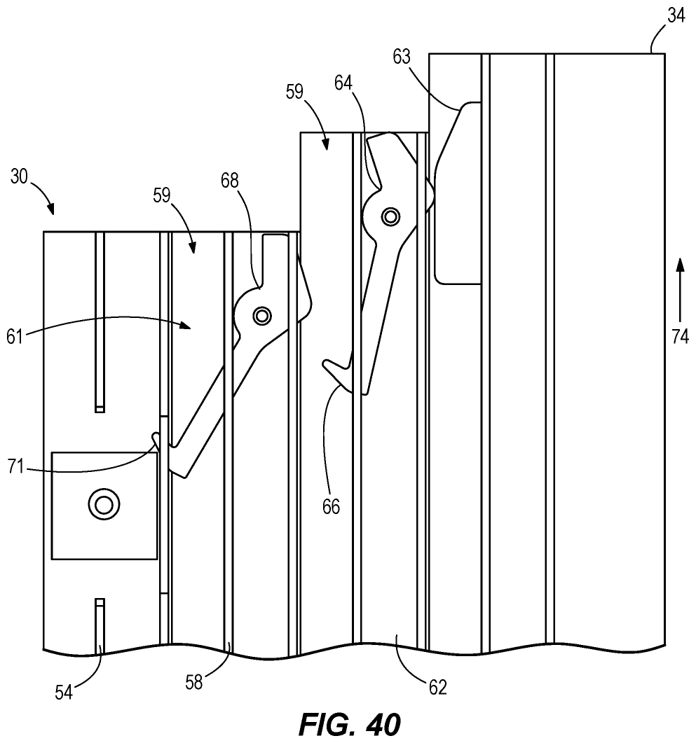

With reference to FIG. 39, to adjust the mast 30 to a first unlocked state, the carriage 34 moves upward relative to the base 14. As the carriage 34 moves, the first cam 63 contacts the first latch 64, pivoting the first latch 64 in a counter-clockwise direction from the frame of reference of FIG. 39 and removing the end 66 of the first latch 64 from the first aperture 65, unlocking the third mast portion 62. The third mast portion 62 is then movable relative to the second and first mast portions 58, 54 respectively (FIG. 40). In the first unlocked state, the carriage 34 and the third mast portion 62 are movable relative to the first and second mast portions 54, 58 respectively. The carriage 34 is adjustable in a first plurality of positions (e.g., heights or locations) relative to a grounded position in the first unlocked state. The second mast portion 58 is locked relative the first mast portion 54 in the first unlocked state (i.e., the second mast portion 58 is not movable relative to the first mast portion 54).

To adjust the mast 30 to a second unlocked state, the carriage 34 and the third mast portion 62 continue to move upward relative to the base 14 (FIG. 41). As the carriage 34 and the third mast portion 62 move, the second cam 67 contacts the second latch 68 pivoting the second latch 68 in a counter-clockwise direction from frame of reference of FIG. 41 and removing the end 71 of the second latch 68 from the second aperture 69, unlocking the second mast portion 58. The second mast portion 58 is then movable relative to the first mast portion 54 and the third mast portion 62. In the second unlocked state, the carriage 34, the third mast portion 62, and the second mast portion 58 are movable relative to the first mast portion 54. The first mast portion 54 remains fixed to the base 14 in the second unlocked state. The carriage 34 is adjustable in a second plurality of positions (e.g., heights or locations) relative to a grounded position in the second unlocked state. The second plurality of positions is greater than the first plurality of positions.

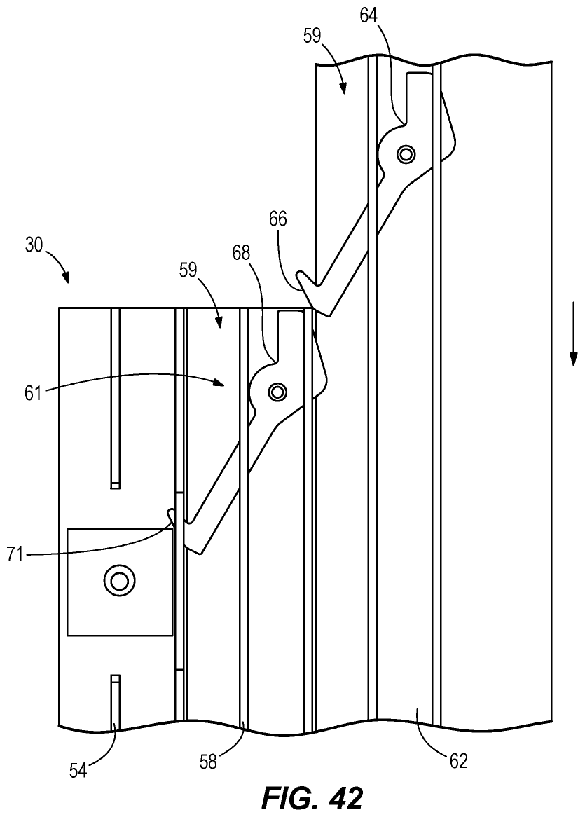

With reference to FIG. 42, the cam and lever mechanism 61 may return to the locked state. To adjust the cam and lever mechanism 61 to the locked state, the mast 30 and carriage 34 move downward (e.g., direction or second direction opposite from the first direction 74) from a predetermined height relative to a grounded position. As the second mast portion 58 moves downward, the end 71 of the second latch 68 contacts the first mast portion 54, pivoting the second latch 68 in a counter-clockwise direction from the frame of reference of FIG. 38 and retracting the second latch 68 against a spring force applied to the second latch 68 relative to the first mast portion 54 into a released position. As the second mast portion 58 continues to move downward, the second latch 68 contacts the first mast portion 54 until the end 71 of the second latch 68 re-seats into the second aperture 69 to lock the second mast portion 58 relative to the first mast portion 54.

As the third mast portion 62 moves downward, the end 66 of the first latch 64 contacts the second mast portion 58, pivoting the first latch 64 in a counter-clockwise direction from the frame of reference of FIG. 38 and retracting the first latch 64 against a spring force applied to the first latch 64 relative to the second mast portion 58 into a released position. As the third mast portion 62 continues to move downward, the first latch 64 contacts the second mast portion 58 until the end 66 of the first latch 64 re-seats into the first aperture 65 to lock the third mast portion 62 relative to the second mast portion 58. Further, as the third mast portion 62 moves downward, the first latch 64 may also contact the second latch 68 to ensure the second latch 68 retracts against a spring force applied to the second latch 68 relative to the first mast portion 54. In particular, the end 66 of the first latch 64 contacts the second latch 68 to retract the second latch 68 relative to the first mast portion 54. The first latch 64 re-aligns the second latch 68 if the mast portions 54, 58, 62 move out of sequence.

In other embodiments, as the third mast portion 62 moves downward, the second cam 67 may contact the second latch 68 to ensure the second latch 68 re-seats into the second aperture 69 to the lock the second mast portion 58 relative to the first mast portion 54. Further, as the carriage 34 moves downward, the first cam 63 may contact the first latch 64 to ensure the first latch 64 re-seats into the first aperture 65 to lock the third mast portion 62 relative to the second mast portion 58. The first cam 63 and the second cam 67 may act as a back-up to ensure the first latch 64 and the second latch 68 retract from the second and first mast portion 58, 54 respectively. The first cam 63 and the second cam 67 ensure the first latch 64 and the second latch 68 re-seat into the first aperture 65 and the second aperture 67.

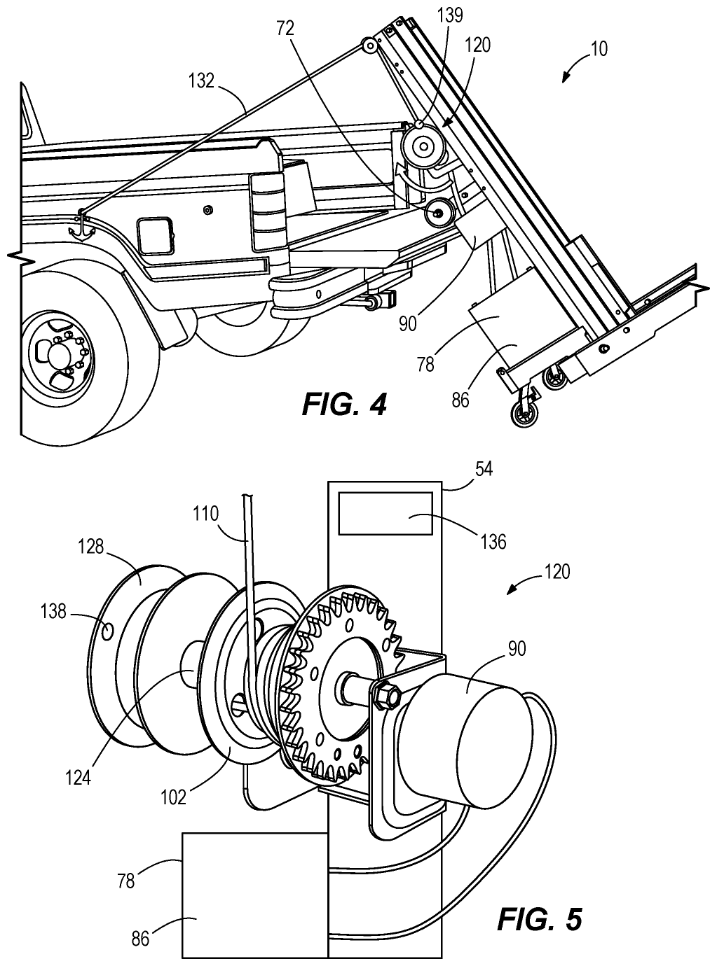

With reference back to FIG. 4, the lifting device 10 includes one or more rollers 72 coupled to the mast 30. Specifically, the one or more rollers 72 are coupled to the first mass portion 48. The one or more rollers 72 are configured to support the lifting device 10 when the lifting device 10 is not supported by the wheels 18 (e.g., mast 30 of the lifting device 10 is tilted relative to a ground or ground plane for transport or storage).

With reference back to FIG. 1, the lifting device 10 includes a lifting assembly 70 that is coupled to the mast 30 and is operable to move the mast 30 and the carriage 34 in a first (vertical) direction 74 to a desired elevation relative to the base 14. The lifting assembly 70 receives electrical power from one or more battery packs 78. The one or more battery packs 78 are rechargeable. The one or more battery packs 78 include a battery chemistry such as, Lithium (“Li”), Lithium-ion (“Li-ion”), other Lithium-based chemistry, or other rechargeable battery chemistry.

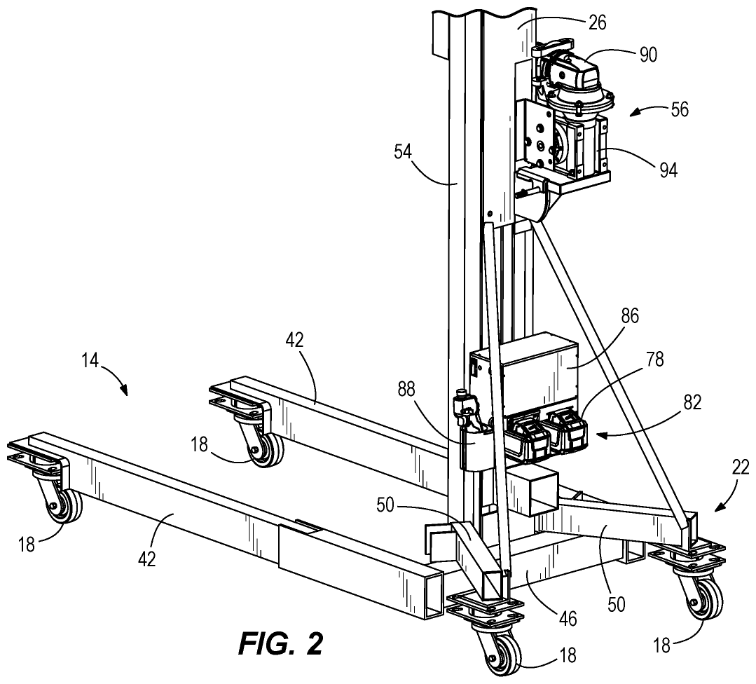

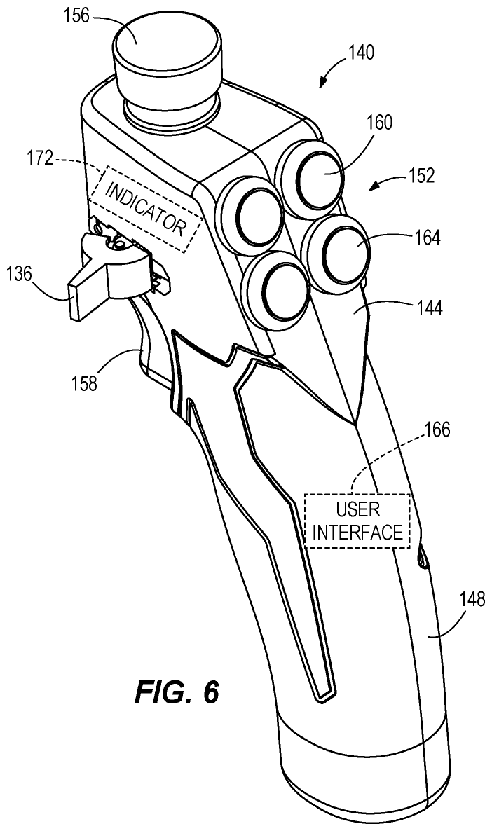

Now with reference to FIG. 2, the one or more battery packs 78 are secured within a battery receptacle 82 that is coupled to the first mast portion 54. An electronics housing 86 is further coupled to the first mast portion 54. As described in more detail below, a remote control unit 140 (FIG. 6) can be detachable from the lifting device 10, and is either in wireless communication with the lifting device 10 or in wired communication with the lifting device 10. The remote control unit 140 (FIG. 6) can be in wireless communication with the lifting device 10 and operable (e.g., via a wireless connection with a transceiver or combination transmitter/receiver housed in the electronics housing 86) to control the movement of the mast 30 and the carriage 34. In other embodiments, the remote control unit 140 can be tethered to the lifting device 10 (e.g., via a wired connection with the electronics housing 86) to control the movement of the mast 30 and the carriage 34. The remote control unit 140 may be housed in a control housing 88 positioned adjacent the battery receptacle 82 (FIG. 2). For example, the control housing 88 is coupled to the battery receptacle 82 (e.g., via fasteners) to allow the operator to store the remote control unit 140 when it is not in use.

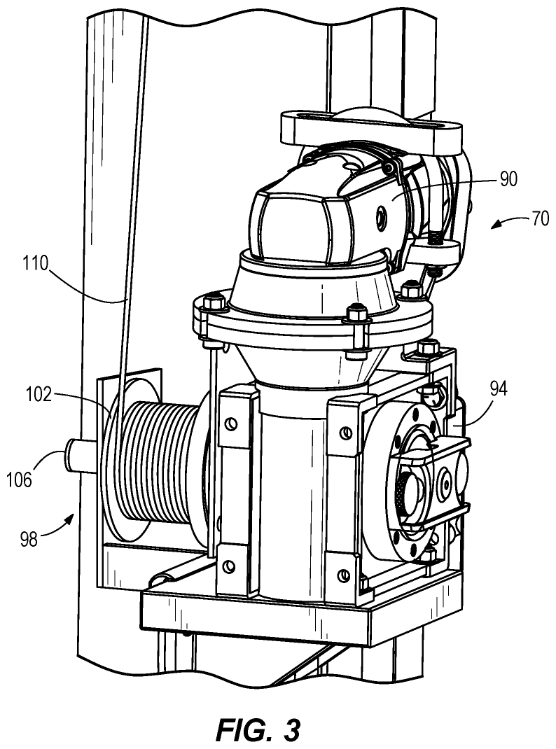

Now with reference to FIG. 3, the lifting assembly 70 is illustrated in detail. The lifting assembly 70 includes an electric motor 90, a gearbox assembly 94, and a winch 98 driven by the electric motor 90. The winch 98 includes a first spool 102 driven by a rotary shaft 106 and a first cable 110 wound around the first spool 102 and coupled to the mast 30. The electric motor 90 is configured to alternately wind and unwind the first cable 110 for raising and lowering the mast 30 relative to the base 14. In the illustrated embodiment, the cable 110 is affixed to the movable mast portions 58, 62 for alternately raising and lowering the movable mast portions 58, 62 relative to the stationary mast portion 48. The gearbox assembly 94 is positioned between and is operable to connect the electric motor 90 and the winch 98.

The electric motor 90 is a brushless direct-current (BLDC) motor having a power output of at least about 1800 W. In some embodiments, the electric motor 90 is a brushless direct-current (BLDC) motor having a power output ranging from 100 W to 4000 W. In one example, the electric motor 90 can be used with a battery pack 78 having a nominal voltage of 80 V. In another example, the electric motor 90 can be used with a battery pack 78 having a nominal voltage of 18 V.

The lifting device 10 includes a total weight. In some embodiments, the total weight of the lifting device 10 does not include the weight of the one or more battery packs 78. In other embodiments, the total weight of the lifting device 10 includes the weight of the one or more battery packs 78. In one embodiment, the total weight of the lifting device 10 is 350 lbs or less without the weight of the one or more battery packs 78. In another embodiment, the total weight of the lifting device 10 is 300 lbs or less without the weight of the one or more battery packs 78.

The lifting device 10 includes a lift height capacity. The lift height capacity is the capability of the lifting device 10 to lift loads or material to a desired height and location (e.g., installation height). The lift height is measured as a distance between a floor that supports the lifting device 10 and the carriage 34 in a direction generally perpendicular to the floor. In one embodiment, the lift height capacity of the lifting device 10 ranges between 9 feet and 28 feet. In another embodiment, the lift height capacity of the lifting device 10 ranges between 14 feet and 18 feet.

The lifting device 10 includes a carrying capacity. The carrying capacity of the lifting device 10 is the carrying capacity of the carriage 34 including the first and second arms 38. The carrying capacity of the carriage 34 is determined by a weight of the load to be lifted and a load center. As shown in FIG. 1, the load center is measured from an interior surface 114 of the carriage 34 to a center of the load in a direction extending perpendicular to the interior surface 114. The load is placed as close as possible to the interior surface 114 to properly lift the load to the desired height and location.

In one embodiment, the carrying capacity of the lifting device 10 ranges between 450 lbs and 1100 lbs. In another embodiment, the carrying capacity of the lifting device 10 ranges between 700 lbs and 900 lbs. In one configuration, the lifting device 10 includes a total weight of 350 lbs or less (i.e., without battery packs 78), a lift height capacity of between 9 feet and 28 feet, and a carrying capacity of 450 lbs and 1100 lbs. In another configuration, the lifting device 10 includes a total weight of 300 lbs or less (i.e., without battery packs 78), a lift height capacity of between 14 feet and 18 feet, and a carrying capacity of between 700 lbs and 900 lbs.

FIGS. 4 and 5 illustrate an auxiliary drive unit 120 that is electrically coupled to the electric motor 90 of the lifting device 10 to selectively raise and lower the lifting device 10. The auxiliary drive unit 120 is operable to raise and lower the lifting device 10 for example, into a vehicle or alongside a building. In some embodiments, the auxiliary drive unit 120 is removably coupled to the electric motor 90 and/or the first spool 102 (FIG. 3). The auxiliary drive unit 120 allows operators to store or transport the lifting device 10 at for example, construction sites or warehouses.

With reference to FIGS. 4 and 5, the auxiliary drive unit 120 includes a shaft 124, a second spool 128, and a second cable 132 routed about the second spool 128. The shaft 124 couples the second spool 128 to the first spool 102 or gearbox assembly 94 of the lifting device 10. The electric motor 90 is coupled to the auxiliary drive unit 120 to provide torque thereto, the electric motor 90 is configured to alternately wind and unwind the second cable 132 for raising and lowering the lifting device 10 relative to a grounded position (FIG. 4). In some embodiments, with continued reference to FIGS. 4 and 5, the second spool 128 includes a female feature 138 configured to receive a male feature 139 of the second cable 132. The female feature 138 of the second spool 128 and the male feature 139 of the second cable 132 interlock with one another to secured the second cable 132 to the second spool 128.

With reference to FIG. 5, the lifting device 10 includes a lever or selector 136 to selectively operate the auxiliary drive unit 120 and the lifting device 10. As illustrated in FIG. 5, in some embodiments, the selector 136 can be onboard the lifting device 10 (e.g., located on the first mass portion 54). In other embodiments, as illustrated in FIG. 6, the selector 136 can be located on the remote control unit 140 as described in more detail below. Actuation of the selector 136 allows an operator to operate the auxiliary drive unit 120 thereby lifting and raising the lifting device 10 relative to the ground. Alternatively, actuation of the selector 136 allows the operator to operate the lifting device 10, thereby raising and lowering the carriage 34 in the first direction 34.

In operation, if removed, the operator couples the auxiliary drive unit 120 to the first spool 102 or the gearbox assembly 94 via the shaft 124. In some embodiments, the first spool 102 may be decoupled from the motor 90, such that the first spool 102 would not receive torque from the motor 90 when it is desired to use the auxiliary drive unit 120 instead. The motor 90 may only provide torque to the second spool 128 when it is desired to use the auxiliary drive unit 120 instead. The second cable 132 is unwound from the second spool 128 and secured to an anchor point (e.g., hook in a vehicle or attachment point alongside a building). The operator actuates the selector 136 to wind the second cable 132 around the second spool 128. As the second cable 132 is wound, the lifting device 10 pivots and is supported by the rollers 66. When the lifting device 10 is at the desired location, the operator deactivates the selector 136 and unlatches the second cable 132 from the anchor point (FIG. 4).

Now with reference to FIG. 6, the lifting device 10 further includes the remote control unit 140. The remote control unit 140 is in wireless communication with a transceiver (i.e., combination transmitter/receiver) housed within the electronics housing 86 (FIG. 2). The wireless communication between the remote control unit 140 and the transceiver is Bluetooth, or other suitable wireless communications. The remote control unit 140 includes a housing 144 defining a handle 148 (e.g., a pistol grip), a first user control 152, a stop button 156, and a trigger 158. The first user control 152 is operable to start the electric motor 90 of the lifting device 10. In some embodiments, the first user control 152 is able to immediately start the electric motor 90 at full or a predetermined initial speed, and then continuously operate the motor 90 at the full or predetermined initial speed thereafter. In other embodiments, the first user control 152 may be capable of starting the electric motor 90 at a predetermined initial speed and slowly accelerate (i.e., “soft start”) the motor 90 to a predetermined or user-selected final speed. Still, in other embodiments, the first user control 152 is receptive of programmable instructions to set a desired lift height of the lifting device 10 such that the motor 90 automatically operates the lifting device 10 to the desired lift height. The first user control 152 is further operable to control the vertical movement (e.g., in the first direction 74) of the mast 30 and carriage 34 relative to the base 14. The stop button 156 is operable to deactivate the electric motor 90 of the lifting device 10.

In one embodiment, the first user control 152 includes an up button 160 and a down button 164 that selectively activates the motor 90 of the lifting assembly 70 (FIG. 1) to move the mast 30 and carriage 34 upward or downward relative to the base 14 (e.g., in the first direction 74). The first user control 152 further selectively activates the motor 90 of the lifting assembly 70 to wind and unwind the first cable 110 about the first spool 102. The stop button 156 is operable to stop, pause, or deactivate the lifting device 10. In some embodiments, when the auxiliary drive unit 120 is coupled to the motor 90, the remote control unit 140 includes the selector 136 to operate the auxiliary drive unit 120.

While the illustrated remote control unit 140 includes a pistol grip, it should be appreciated that the remote control unit 140 may have an alternative shape. At the same time, it should be appreciated that the user controls 136, 152, 156 may take different forms other than buttons (e.g., dial, touch screen display, switches, levers, etc.).

In some embodiments, with reference to FIGS. 1 and 6, the remote control unit 140 further includes an user interface 166. In other embodiments, the user interface 166 can be onboard the lifting device 10. The user interface 166 is operable to communicate information about the lifting device 10 to the operator of the lifting device 10. The user interface 166 can include one or more light emitting diodes (i.e., LEDs). The user interface 166 can further include a liquid crystal display (LCD) display. As described below, the user interface 166 can communicate information about a status of the lifting device 10 according to one or more metrics measured by one or more sensors 168 (FIG. 6). For example, the user interface 166 can communicate information about a weight and/or a center of gravity of a load to be lifted by the lifting device 10, a voltage of the one or more battery packs 78, and/or a number of lifts performed by the lifting device 10. In another example, the user interface 166 communicates a height of the carriage 34 from the floor through the LCD display.

In operation, the operator sends instructions wirelessly to the lifting device 10 via the remote control unit 140 to operate the lifting assembly 70, and therefore, raise and lower the mast 30 and the carriage 34. The remote control unit 140 allows for remote operation of the lifting device 10 and reduces the manual labor required to operate the lifting device 10. The remote control unit 140 alleviates strain on the operator by removing the need to manually crank a hand wheel/lever to raise and lower the mast 30 and the carriage 34.

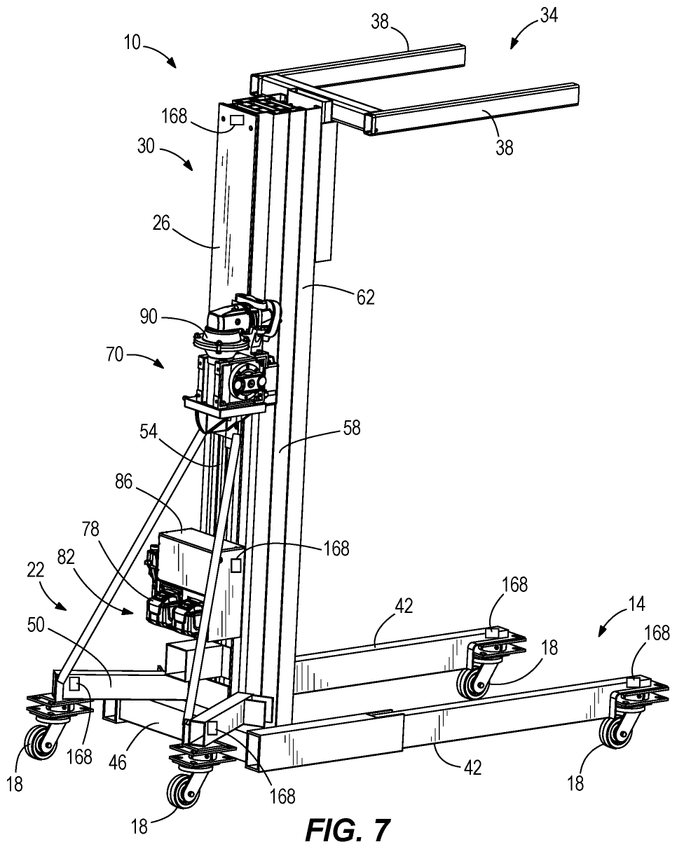

FIG. 7 illustrates the lifting device 10 further including a means for detecting a status of the lifting device 10 according to one or more metrics. The lifting device 10 includes at least one sensor 168 configured to measure a status of the lifting device 10 according to one or more metrics such as a load carrying capacity, a cable tension, a current of the motor, a battery charge, a battery voltage, a battery low-voltage state, a number of lifts performed by the lifting device 10, a predetermined or maximum number of lifts performed by the lifting device 10, a height of the carriage 34 from the floor, etc. The sensors 168 are positioned on the base 14 to measure a load carrying capacity on the wheels 18. In some embodiments, the sensors 168 are located on the first spool 102 or first cable 110 to measure a force or tension in the first cable 110. In some embodiments, the one or more sensors 168 can be an impedance measurement circuit connected to the first cable 110 configured to detect an increase in impedance due to cable fray, stretching, and/or damage.

In some embodiments, the sensors 168 are positioned in the one or more battery packs 78 to measure a charge or voltage of the one or more battery packs 78. In other embodiments, the sensors 168 are positioned within the electronics housing 86 to measure a status of the control electronics or a current of the motor 90. The sensors 168 can further track the power usage of the lifting device 10. Further, the sensors 168 can measure if a load's center of gravity is outside a support rectangle of the base 14. In still other embodiments, the sensors 168 can track a maximum lift height of the lifting device 10 and a lower lift height limit of the lifting device 10. The lifting device 10 prevents the operator from operating the lifting device 10 past the maximum lift height and lower than the lower lift height limit. In still other embodiments, the sensors 168 can detect a minimum battery voltage of the battery packs 78 needed for the lifting device 10 to complete a last lift (i.e., operating the lifting device 10 to complete one more lift to the maximum lift height and returning to the lower lift height limit before there's insufficient voltage in the battery packs 78 to perform another lift).

With reference back to FIG. 6, in some embodiments, the remote control unit 140 includes an indicator 172 to alert the operator of the status of the lifting device 10. In other embodiments, the indicator 172 is onboard the lifting device 10 to alert the operator of the status of the lifting device 10. The indicator 172 can alert the operator of the status of the lifting device 10 with the one or more dedicated light emitting diodes (e.g., LEDs) on the housing of the remote control unit 140. Or, in other embodiments, the indicator 172 may be integrated with the user interface 166, permitting the indicator 172 to alert the operator of the status of the lifting device 10 through the LCD display screen of the user interface 166. For example, the indicator 172 can include, but not limited to, an indication of when the load exceeds a safe operating limit of the lifting device 10, an indication of when the one or more battery packs 78 are depleted, an indication of when the first cable 110 is damaged or unusable for a lifting operation, an indication of when a load's center of gravity is outside the support rectangle of the base 14, or identify an operating state or idling state of the lifting device 10. In still other embodiments, the indicator 172 can include, but not limited to, an alert of a last or final lift capable of the one or more battery packs 78, or an alert of when the lifting device 10 exceeds a predetermined or maximum number of lifts capable of the one or more battery packs 78. The alert indicating of when the lifting device 10 exceeds the predetermined number of lifts can indicate that the operator needs to replace the first cable 110. In still other embodiments, the indicator 172 can include an alert of when the lifting device 10 is at a maximum lift height or a lower lift height limit.

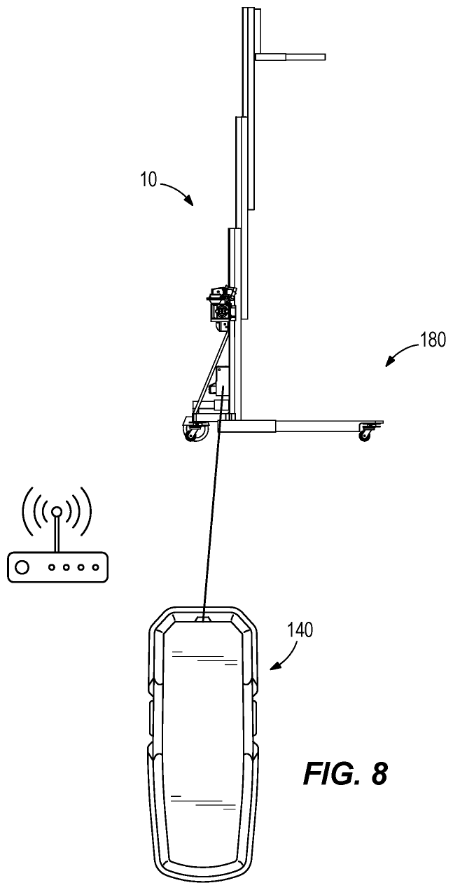

FIG. 8 illustrates a schematic view of a lifting system 180 according to an embodiment of the invention. The lifting system 180 includes the lifting device 10 (FIG. 1) and the remote control unit 140 (FIG. 6). The remote control unit 140 is in wireless communication with the lifting device 10. The lifting device 10 requires actuation of the trigger 158 onboard the remote control unit 140 to operate the lifting device 10. Actuation of the trigger 158 allows the operator to alternately raise and lower the carriage 34 of the lifting device 10 in the first direction 74 via a wireless connection. The lifting system 180 is configured to allow the operator to lift and transport materials with the lifting device 10 via the remote control unit 140. The lifting system 180 allows a single operator to operate the lifting device 10.

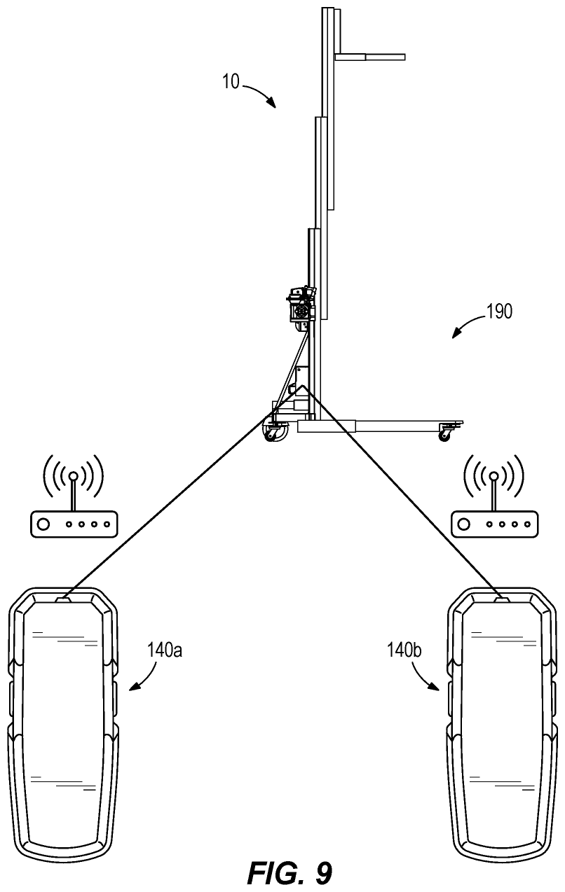

FIG. 9 illustrates a schematic view of a lifting system 190 according to another embodiment of the invention. The lifting system 190 includes the lifting device 10 (FIG. 1), a first remote control unit 140a, and a second remote control unit 140b. The remote control unit 140a, 140b is similar to the remote control unit 140 described above (FIG. 6), with like parts having the same reference number plus the letter “a” or “b”, and the following differences explained below. The remote control unit 140a is similar to the remote control unit 140b, with like parts having the same reference numeral plus the letter “b”, and the following differences explained below.

The first remote control unit 140a and the second remote control unit 140b are in wireless communication with the lifting device 10. The first remote control unit 140a alternately raises and lowers the carriage 34 of the lifting device 10 via a wireless connection. In some embodiments, the second remote control unit 140b can alternately raise and lower the carriage 34 of the lifting device 10 via a wireless connection. In other embodiments, the second remote control unit 140b can provide a stop or pause function to deactivate operation of the lifting device 10.

In still other embodiments, the first remote control unit 140a and the second remote control unit 140b both need to be in wireless communication with the lifting device 10. In these embodiments, the first remote control unit 140a includes a first trigger 158a, and the second remote control unit 140b includes a second trigger 158b. The lifting device 10 requires actuation of at least one of the first trigger 158a and the second trigger 158b to operate the lifting device 10. Actuation of at least one of the first trigger 158a and second trigger 158b allows the operator to alternately raise and lower the carriage 34 of the lifting device 10 in the first direction 74 via a wireless connection. The first remote control unit 140a and the second remote control unit 140b allows two operators to operate the lifting system 190 to better monitor the lifting and transporting of materials with the lifting device 10.

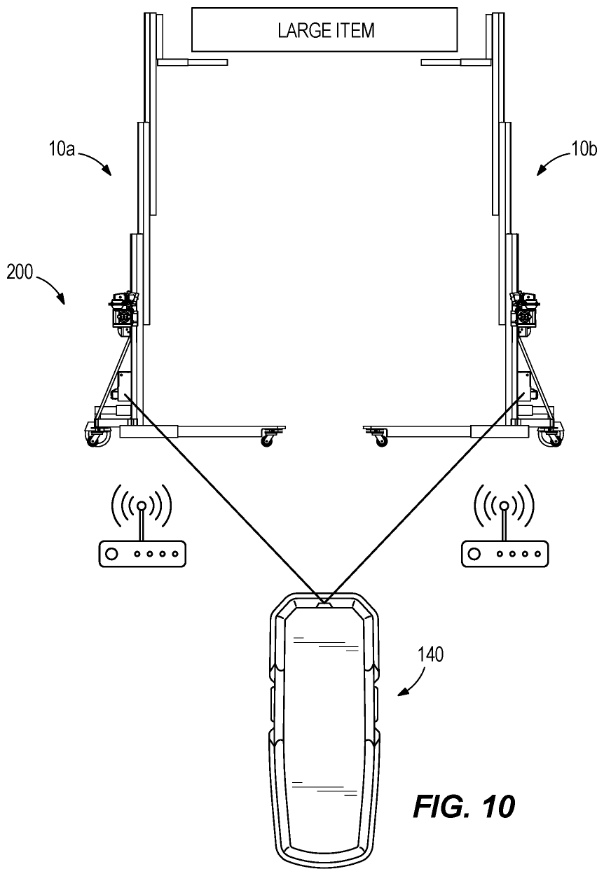

FIG. 10 illustrates schematic view of a lifting system 200 according to another embodiment of the invention. The lifting system 200 includes a first lifting device 10a, a second lifting device 10b, and the remote control unit 140 (FIG. 6). The lifting device 10a, 10b is similar to the lifting device 10 described above (FIG. 1), with like parts having the same reference number plus the letter “a” or “b”, and the following differences explained below. The first lifting device 10a is similar to the second lifting device 10b, with like parts having the same reference numeral plus the letter “b”, and the following differences explained below.

The remote control unit 140 is in wireless communication with the first lifting device 10a and the second lifting device 10b. The remote control unit 140 alternately raises and lowers a carriage 34a of the first lifting device 10a via a wireless connection. The remote control unit 140 alternately raises and lowers a carriage 34b of the second lifting device 10b via a wireless connection. The remote control unit 140 is in wireless communication with both the first lifting device 10a and the second lifting device 10b allows for a synchronized lift of large or heavy materials. The lifting device 10a, 10b requires actuation of the trigger 158 onboard the remote control unit 140 to operate the lifting device 10a, 10b. Actuation of the trigger 158 allows the operator to alternately raise and lower the carriage 34a, 34b of the lifting device 10a, 10b respectively in the first direction 74 via a wireless connection. The remote control unit 140 allows for a single operator to operate the first lifting device 10a and the second lifting device 10b. The remote control unit 140 in wireless communication with both the first and second lifting device 10a, 10b prevents the lifting devices 10a, 10b from operating individually (e.g., prevents large materials from being unbalanced during the lifting operation).

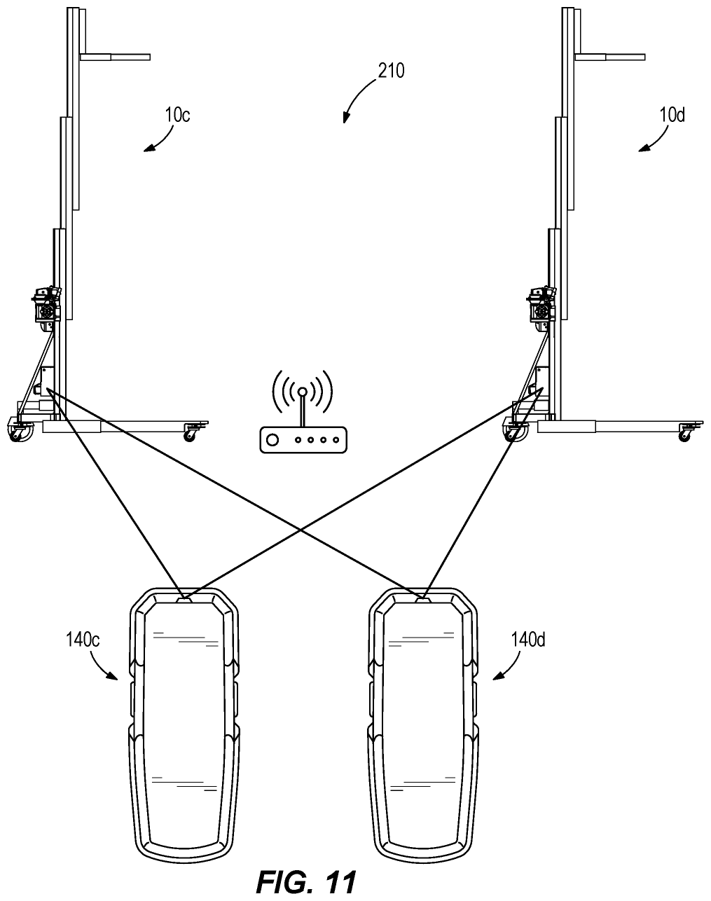

FIG. 11 illustrates a schematic view of a lifting system 210 according to another embodiment of the invention. The lifting system 210 includes a first lifting device 10c, a second lifting device 10d, a first remote control unit 140c, and a second remote control unit 140d. The lifting device 10c, 10d is similar to the lifting device 10 described above (FIG. 1). The first lifting device 10c is similar to the second lifting device 10d, with like parts having the same reference numeral plus the letter “d”, and the following differences explained below. The remote control unit 140c, 140d is similar to the remote control unit 140 described above (FIG. 6). The first remote control unit 140c is similar to the second remote control unit 140d, with like parts having the same reference numeral plus the letter “d”, and the following differences explained below.

With continued reference to FIG. 11, the first remote control unit 140c and the second remote control unit 140d are in wireless communication with the first lifting device 10c and the second lifting device 10d. The first remote control unit 140c alternately raises and lowers a carriage 34c, 34d of one or both the first lifting device 10c and the second lifting device 10d respectively via a wireless connection. The second remote control unit 140d alternately raises and lowers the carriage 34c, 34d of one or both of the first lifting device 10c and the second lifting device 10d respectively via a wireless connection. In some embodiments, the second remote control unit 140d can provide a stop or pause function to deactivate the operation of the first lifting device 10a or second lifting device 10b.

In still other embodiments, the first and second remote control unit 140c, 140d both need to be in wireless communication with the first lifting device 10c or the second lifting device 10d. In these embodiments, the first remote control unit 140c includes a first trigger 158c, and the second remote control unit 140d includes a second trigger 150d. The lifting device 10c, 10d requires actuation of at least one of the first trigger 150c and the second trigger 150d to operate the lifting device 10c, 10d. Actuation of at least one of the first trigger 150c and the second trigger 150d allows the operator to alternately raise and lower the carriage 34c, 34d of the lifting device 10c, 10d respectively in the first direction 74 via a wireless connection. The first remote control unit 140c and the second remote control unit 140d allows two operators to operate the lifting system 210 to better monitor the lifting and transporting of materials.

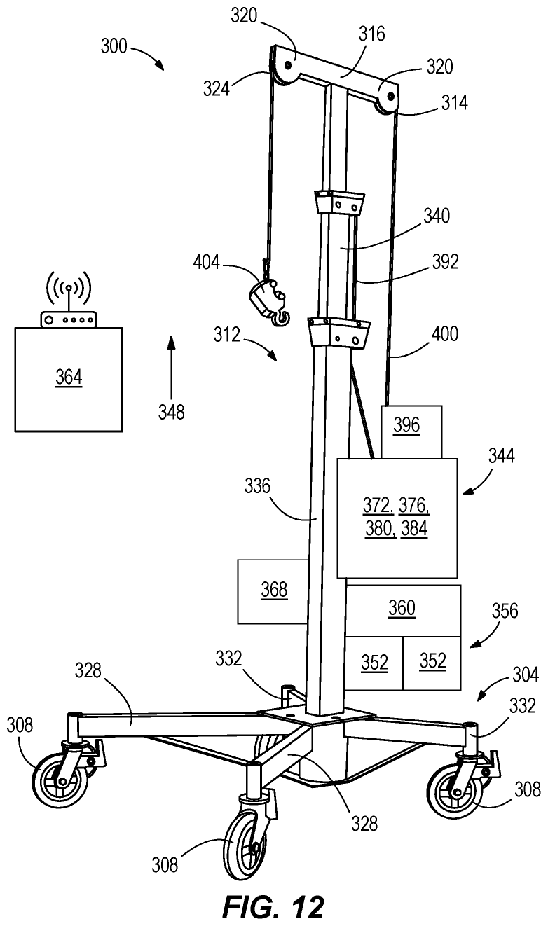

FIG. 12 illustrates a lifting device 300 according to another embodiment of the invention. The lifting device 300 is able to lift materials (e.g., pipes, weights, loads, etc.) and move the material to a desired height and location (e.g., an installation height). The lifting device 300 is a roust-a-about lift. The lifting device 300 is similar to the lifting device 10 described above, and the following differences explained below. The lifting device 300 includes a base 304 having a plurality of wheels 308, a mast 312 extending from the base 304, and a post 316 coupled to the mast 312. The post 316 includes first and second arms 320 that extend from the post 316. The first and second arms 320 include one or more pulleys 324.

In the illustrated embodiment, the base 304 includes first and second base rails 328 that obliquely extend from the base 304, and an additional two frame rails 332 that obliquely extend from the base 304. The wheels 308 are coupled to a distal end of each of the rails 328, 332. As a result, wheels 308 are positioned in each corner of the base 304. In some embodiments, the first and second base rails 328 may pivot relative to the base 304 to facilitate movement and storage of the lifting device 300. In some embodiments still, the first and second base rails 328 may extend away (e.g., telescoping) from the base 304 to accommodate different material weights supported by the lifting device 300.

The mast 312 includes a first (stationary) mast portion 336 that is rigidly coupled to the base 304, and a second (movable) mast portion 340 that is coupled to and movable relative to the first mast portion 336. In other embodiments, more or fewer mast portions may be used. In the illustrated embodiment, each mast portion 336, 340 of the mast 312 includes a telescoping structure that engages with a corresponding mast portion so the mast 312 and the post 316 are movable between a plurality of positions. For example, the telescoping structures may be arranged such that the second (movable) mast portion 340 is received within the first (stationary) mast portion 336, and the post 316 is received within the second (movable) mast portion 340. The post 316 and the second mast portion 340 are movable relative to the stationary mast portion 336 and the base 304.

With reference to FIG. 12, the lifting device 300 includes a lifting assembly 344 that is coupled to the mast 312 and is operable to move the mast 312 and the post 316 in a first (vertical) direction 348 to a desired elevation relative to the base 304. The lifting assembly 344 receives electrical power from one or more battery packs 352. The one or more battery packs 352 are rechargeable. The one or more battery packs 352 include a battery chemistry such as, Lithium (“Li”), Lithium-ion (“Li-ion”), other Lithium-based chemistry, or other rechargeable battery chemistry. The one or more battery packs 352 is similar to the one or more battery packs 78 of lifting device 10 described above.

With continued reference to FIG. 12, the one or more battery packs 352 are secured within a battery receptacle 356 that is coupled to the first mast portion 336. An electronics housing 360 is further coupled to the first mast portion 336. As described above, a remote control unit 364 can be detachable from the lifting device 300, and is either in wireless communication with the lifting device 300 or in wired communication with the lifting device 300. The remote control unit 364 can be in wireless communication with the lifting device 300 and operable (e.g., via a wireless connection with a transceiver or combination transmitter/receiver housed in the electronics housing 360) to control the movement of the mast 312 and the post 316. In other embodiments, the remote control unit 364 can be tethered to the lifting device 300 (e.g., via a wired connection with the electronics housing 360) to control the movement of the mast 312 and the post 316. The remote control unit 364 may be housed in a control housing 368 positioned adjacent the battery receptacle 356 (FIG. 12). For example, the control housing 368 is coupled to the battery receptacle 356 (e.g., via fasteners) to allow the operator to store the remote control unit 364 when it is not in use.

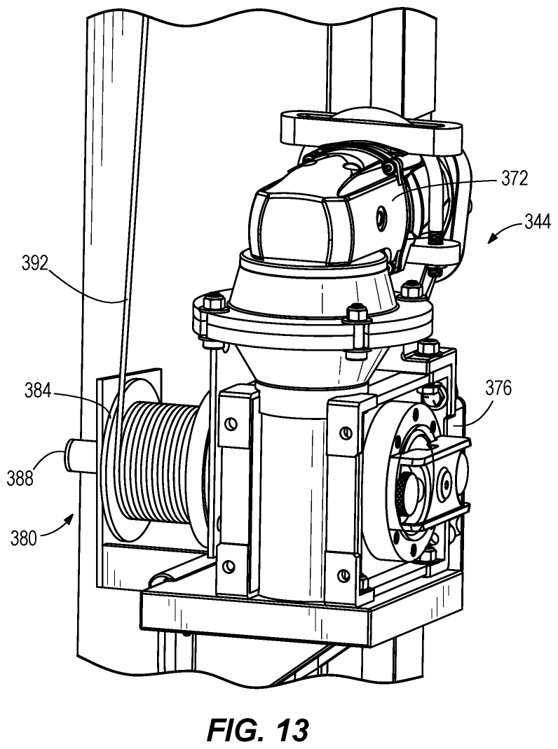

With reference to FIG. 13, the lifting assembly 344 is illustrated in detail. The lifting assembly 344 includes an electric motor 372, a gearbox assembly 376, and a winch 380 driven by the electric motor 372. The winch 380 includes a first spool 384 driven by a rotary shaft 106 and a first cable 392 wound around the first spool 384 and coupled to the mast 312. The electric motor 372 is configured to alternately wind and unwind the first cable 392 for raising and lowering the mast 312 relative to the base 304. In the illustrated embodiment, the cable 392 is affixed to the second moveable mast portion 340 and post 316 for alternately raising and lowering the second movable mast portion 340 and the post 316 relative to the stationary mast portion 336. The gearbox assembly 376 is positioned between and is operable to connect the electric motor 372 and the winch 380. The lifting assembly 344 further includes a lifting spool 396 and a lifting cable 400 coupled to the electric motor 372. The lifting cable 400 is routed about the lifting spool 396 and the one or more pulleys 324 of the post 316. A clamp or hook element 404 is attached to an end of the lifting cable 400. The clamp or hook element 404 is configured to be secured to a load or material (e.g., pipe). The electric motor 372 is coupled to the lifting spool 396 to provide torque thereto, the electric motor 372 is configured to alternately wind and unwind the lifting cable 400 for raising and lowering a load or material relative to the ground.

The electric motor 372 is a brushless direct-current (BLDC) motor having a power output of at least about 1800 W. The electric motor 372 is similar to the electric motor 90 described above. In some embodiments, the electric motor 372 is a brushless direct-current (BLDC) motor having a power output ranging from 100 W to 4000 W. In one example, the electric motor 372 can be used with a battery pack 78 having a nominal voltage of 80 V. In another example, the electric motor 372 can be used with a battery pack 78 having a nominal voltage of 18 V.

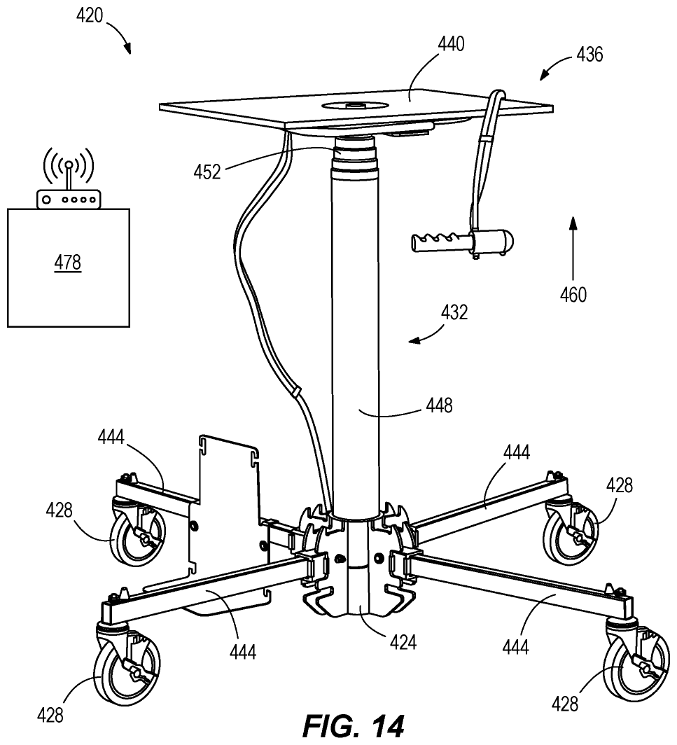

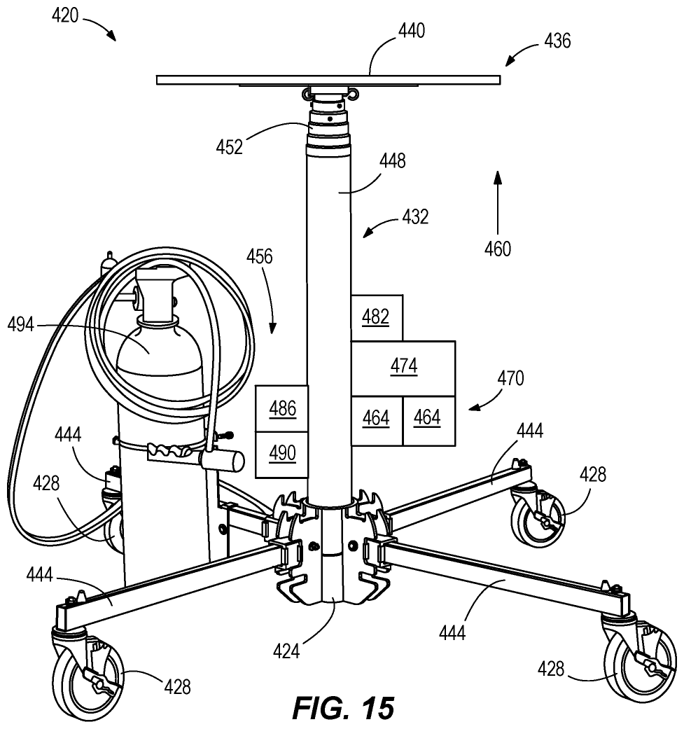

FIGS. 14 and 15 illustrates a lifting device 420 according to another embodiment of the invention. The lifting device 420 is able to rigidly (e.g., lift from below) lift materials (e.g., pipes, weights, loads, etc.) and move the material to a desired height and location (e.g., an installation height). The lifting device 420 is a CO2-style lift. The lifting device 420 includes a base 424 having a plurality of wheels 428, a mast 432 extending from the base 424, and a carriage 436 coupled to the mast 432. The carriage 436 includes a flat plate 440. In other embodiments, the carriage 436 includes one or more arms.

As shown in FIGS. 14 and 15, the base 424 includes rails 444 that extend from the base 424. In the illustrated embodiment, the base 424 includes four rails 444. The wheels 428 are coupled to a distal end of each of the rails 444. As a result, wheels 428 are positioned in each corner of the base 424. In some embodiments, the rails 444 may pivot relative to the base 424 (e.g., foldable, move inward toward the base 424 and mast 432) to facilitate movement and storage of the lifting device 420. In some embodiments, the rails 444 extend away (e.g., telescoping) from the base 424 to accommodate different material weights supported by the lifting device 420.

The mast 432 includes a first (stationary) mast portion 448 that is rigidly coupled to the base 424, and second (movable) mast portion 452 that is coupled to and movable relative to the first mast portion 448. In other embodiments, more or fewer mast portions may be used. In the illustrated embodiment, each mast portion 448, 452 of the mast 432 includes a telescoping structure that engages with a corresponding mast portion so the mast 432 and the carriage 436 are movable between a plurality of positions. For example, the telescoping structure (e.g., telescoping cylinders, tubes, members) may be arranged such that the second mass portion 452 is received within the first mass portion 448. The second mass portion 452 is movable relative to the first mass portion 448 and the base 424.

With reference back to FIG. 15, the lifting device 420 includes a lifting assembly 456 that is coupled to the mast 432 and is operable to move the mast 432 and the carriage 436 in a first (vertical) direction 460 to a desired elevation relative to the base 424. The lifting assembly 456 receives electrical power from one or more battery packs 464. The one or more battery packs 464 are rechargeable. The one or more battery packs 464 include a battery chemistry such as, Lithium (“Li”), Lithium-ion (“Li-ion”), other Lithium-based chemistry, or other rechargeable battery chemistry.

Now with reference to FIG. 14, the one or more battery packs 464 are secured within a battery receptacle 470 that is coupled to the first mast portion 448. An electronics housing 474 is further coupled to the first mast portion 448. As described above, a remote control unit 478 can be detachable from the lifting device 420, and is either in wireless communication with the lifting device 420 or in wired communication with the lifting device 420. The remote control unit 478 is similar to the remote control unit 140 described above. The remote control unit 478 can be in wireless communication with the lifting device 420 and operable (e.g., via a wireless connection with a transceiver or combination transmitter/receiver housed in the electronics housing 474) to control the movement of the mast 432 and the carriage 436. In other embodiments, the remote control unit 478 can be tethered to the lifting device 420 (e.g., via a wired connection with the electronics housing 474) to control the movement of the mast 432 and the carriage 436. The remote control unit 478 may be housed in a control housing 482 positioned adjacent the battery receptacle 470. For example, the control housing 482 is coupled to the battery receptacle 470 (e.g., via fasteners) to allow the operator to store the remote control unit 478 when it is not in use.

Now with reference to FIG. 15, the lifting assembly 456 is illustrated in detail. The lifting assembly 456 includes an electric motor 486, and a compressor 490 including a tank 494 affixed to the lifting device 420. The tank 494 is filled with a gas such as air or CO2. The electric motor 486 is configured to alternately pressurized or de-pressurized the gas within the tank 494 which is used for raising and lowering the mast 432 relative to the base 424. In the illustrated embodiment, the gas is used to alternately raise and lower the movable mass portion 452 relative to the stationary mass portion 448.

The electric motor 486 is a brushless direct-current (BLDC) motor having a power output of at least about 1800 W. In some embodiments, the electric motor 486 is a brushless direct-current (BLDC) motor having a power output ranging from 100 W to 4000 W. In one example, the electric motor 486 can be used with a battery pack 464 having a nominal voltage of 80 V. In another example, the electric motor 486 can be used with a battery pack 464 having a nominal voltage of 18 V.

FIG. 17 illustrates a cradle 500 for use with the lifting device 10. The cradle 500 is coupled to the first and second arms 38. The cradle 500 includes ramps 504 that are coupled to each arm 38. The ramps 504 are angled such that a first height of the ramps 504 is greater near a distal end of each arm 38 than a second height of the ramps 504 near the mast 30. The cradle 500 is configured to securely hold a pipe or material on the first and second arms 38. The pipe or material is supported adjacent the mast 30. A user may remotely operate the lifting device 10 including the cradle 500 with a remote control unit as described in this disclosure.

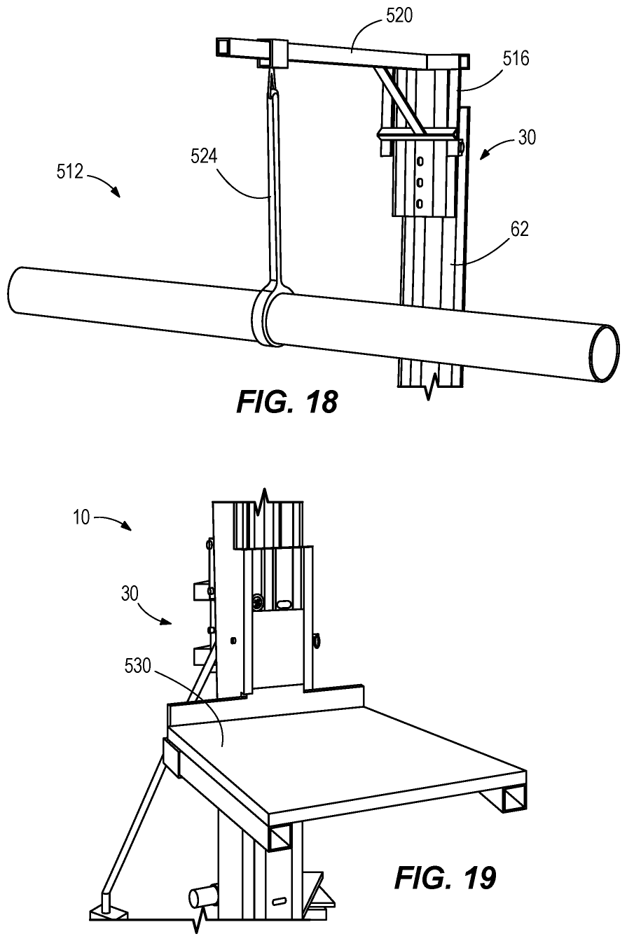

FIG. 18 illustrates a boom 512 for use with the lifting device 10. The boom 512 is coupled to the mast 30, in particular the movable third mass portion 62. The boom 512 includes a boom base 516, a boom arm 520, and a boom cable 524. The boom base 516 is coupled to the mast 30 with fasteners, the boom arm 520 extends from boom base 516 away from the mass 30, and the boom cable 524 is coupled to a distal end of the boom arm 520. The boom cable 524 is configured to wrap around a pipe or material to be lifted by the lifting device 10. In some embodiments, the boom cable 524 is a chain, a wire, or a cord. A user may remotely operate the lifting device 10 including the boom 512 with a remote control unit as described in this disclosure.

FIG. 19 illustrates a pan 530 for use with the lifting device 10. The pan 530 is coupled to the carriage 34, and in particular the first and second arms 38. The pan 530 may be a flat plate. The pan 530 provides a flat surface such that materials are supported by the flat surface of the pan 530 during the lifting operation. A user may remotely operate the lifting device 10 including the pan 530 with a remote control unit as described in this disclosure.

FIG. 21 illustrates a pad 540 for use with the lifting device 10, 300, 420 described above. In one example, the pad 540 is coupled to the carriage 34, and in particular the first and second arms 38. In one example, the pad 540 may be an anti-scratch pad 540 that protects the carriage 34 from materials placed on the carriage 34. A user may remotely operate the lifting device 10, 300, 420 including the pad 540 with a remote control unit as described in this disclosure.

FIG. 23 illustrates a roller platform 550 for use with the lifting device 10. The roller platform 550 is coupled to the carriage 34, and in particular the first and second arms 38. The roller platform 550 includes a frame 554 and a plurality of rollers 558. The roller platform 550 is configured to allow a user to easily place and remove materials from the carriage 34 of the lifting device 10. A user may remotely operate the lifting device 10 including the roller platform 550 with a remote control unit as described in this disclosure.

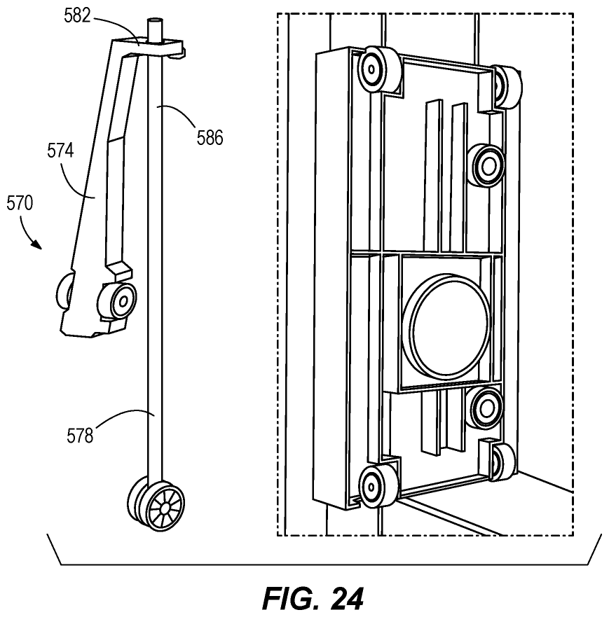

FIG. 24 illustrates a brake mechanism 570 for use with the lifting device 10. In other embodiments, the brake mechanism 570 may be used with the lifting device 300, 420. The brake mechanism 570 is coupled to the mast 30. In the illustrated embodiment, the brake mechanism 570 includes a lever 574 and a pin 578. The lever 574 includes an eyelet 582 at a distal end of the lever 574 configured to receive the pin 578. The pin 578 includes one or more protrusions 586. The lever 574 and the pin 578 are rotatable and move relative to the mast 30. When the mast 30 is at the desired height and location, the eyelet 582 receives the pin 578, and the lever 574 abuts a protrusion 586 on the pin 578. The engagement between the lever 574 and the pin 578 locks the mast 30, and in particular locks the moveable mass portions 58, 62 relative to the first mass portion 54 (FIG. 1). In other embodiments, the brake mechanism 570 may further include a pawl and ratchet mechanism or brake pads. A user may remotely operate the lifting device 10 including the brake mechanism 570 with a remote control unit as described in this disclosure.

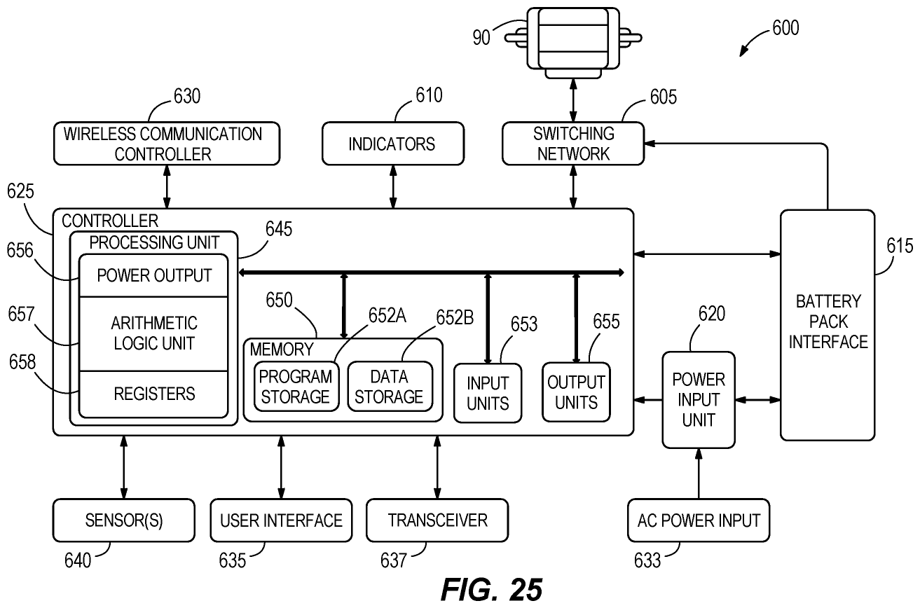

FIG. 25 illustrates a control system 600 of the lifting device 10 including a switching network 605, indicators 610, a battery pack interface 615, a power input unit 620, a controller 625, a wireless communication controller 630, and an AC power input 633, a user interface 635, a transceiver 637, and a plurality of sensors 640. The battery pack interface 615 is coupled to the controller 625 and couples to the battery pack 78. The battery pack interface 615 includes a combination of mechanical components (e.g., the battery receptacle 82) and electrical components configured to and operable for interfacing (e.g., mechanically, electrically, and communicatively connecting) the lifting device 10 with a battery pack 78. The battery pack interface 615 is coupled to the power input unit 620. The battery pack interface 615 transmits the power received from the battery pack 78 to the power input unit 620. The power input unit 620 is additionally coupled to the AC power input 633. The power input unit 620 includes active and/or passive components (e.g., voltage step-down controllers, voltage converters, rectifiers, filters, etc.) to regulate or control the power received through the battery pack interface 222 and the AC power input 633 to the controller 625. The power input unit 620 may be configured to charge the battery pack 78 through the battery pack interface 615.

The switching network 605 enables the controller 625 to control the operation of the motor 90. The switching network 605 controls the amount of current available to the motor 90 and thereby controls the speed and torque output of the motor 90. Generally, the switching network 605 controls the motor 90 based on commands from the user interface 635, the transceiver 637, and/or the wireless communication controller 630. The switching network 605 may include a plurality of switches (e.g., FETs, etc.). For instance, the switching network 605 may include a six-FET bridge that receives pulse-width modulated (PWM) signals from the controller 625 to drive the motor 90.

The transceiver 637 is coupled to the controller and communicates to the controller control signals communicated through the remote control unit 140. In some embodiments, the transceiver may serve as an additional user interface 635 and may communicate control signals based on a user input. In some embodiments, the transceiver 637 may be separate from the user interface 635 and communicate additional or other information to the controller 625.

The sensors 640 are coupled to the controller 625 and communicate to the controller 625 various signals indicative of different parameters of the lifting device 10 or the motor 90. The sensors 640 may include Hall effect sensors, one or more current sensors, one or more voltage sensors, one or more temperature sensors, one or more torque sensors, etc. For example, based on the motor feedback information from the Hall effect sensors, the controller 625 can determine the position, velocity, and acceleration of the rotor. In response to the motor feedback information and the signals from the wireless communication controller 630, the user interface 635, and/or the transceiver 637, the controller 625 transmits control signals to control the switching network 605 to drive the motor 90. For instance, by selectively enabling and disabling the switches of the switching network 605, power received via the battery pack interface 615 is selectively applied to stator coils of the motor 90 to cause rotation of its rotor. The motor feedback information is used by the controller 625 to ensure proper timing of control signals to the switching network 605 and, in some instances, to provide closed-loop feedback to control the speed of the motor 90 to be at a desired level.

The indicators 610 are also coupled to the controller 625 and receive control signals from the controller 625 to turn ON and OFF or otherwise convey information based on different states of the lifting device 10. The indicators 610 include, for example, one or more light-emitting diodes (“LED”), or a display screen. The indicators 610 can be configured to display conditions of, or information associated with, the lifting device 10. For example, the indicators 610 are configured to indicate measured electrical characteristics of the lifting device 10, the status of the lifting device 10, etc. The indicators 610 may also include elements to convey information to a user through audible or tactile outputs.

As described above, the controller 625 is electrically and/or communicatively connected to a variety of modules or components of the lifting device 10. In some embodiments, the controller 625 includes a plurality of electrical and electronic components that provide power, operational control, and protection to the components and modules within the controller 625 and/or lifting device 10. For example, the lifting device 10 includes, among other things, a processing unit 645 (e.g., a microprocessor, a microcontroller, an electronic processor, an electronic controller, or another suitable programmable device), a memory 650, input units 653, and output units 655. The processing unit 645 includes, among other things, a control unit 656, an arithmetic logic unit (“ALU”) 657, and a plurality of registers 658 (shown as a group of registers in FIG. 25). In some embodiments, the controller 625 is implemented partially or entirely on a semiconductor (e.g., a field-programmable gate array [“FPGA”] semiconductor) chip, such as a chip developed through a register transfer level (“RTL”) design process.

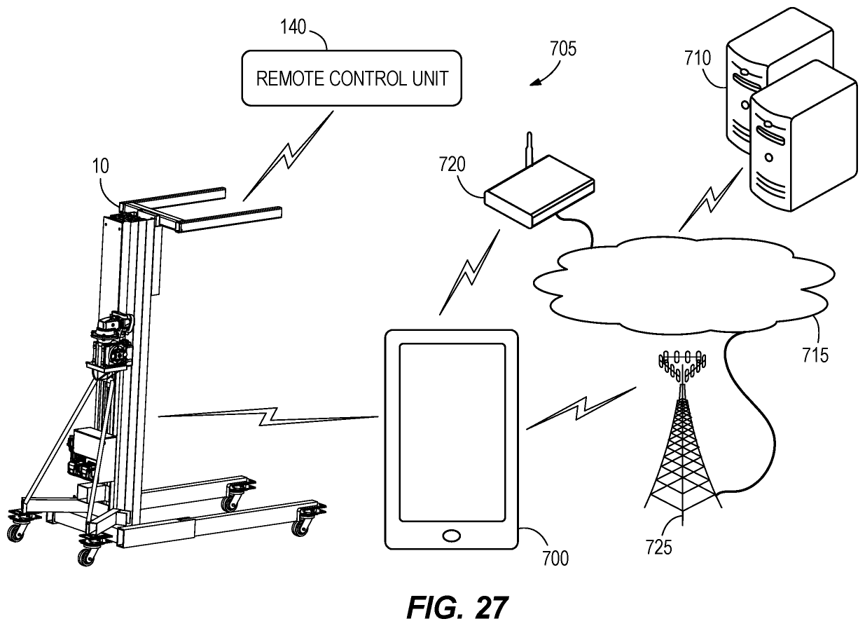

The memory 650 is a non-transitory computer readable medium and includes, for example, a program storage area 652A and a data storage area 652B. The program storage area 652A and the data storage area 652B can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 645 is connected to the memory 650 and executes software instructions that are capable of being stored in a RAM of the memory 650 (e.g., during execution), a ROM of the memory 650 (e.g., on a generally permanent basis), or another non-transitory computer readable medium such as another memory or a disc. Software included in the implementation of the lifting device 10 can be stored in the memory 650 of the controller 625. The software includes, for example, firmware, one or more applications, program data, filters, rules, one or more program modules, and other executable instructions. The controller 625 is configured to retrieve from memory 650 and execute, among other things, instructions related to the control processes and methods described herein. The controller 625 is also configured to store power tool information on the memory 650 including operational data, information identifying the type of tool, a unique identifier for the particular tool, and other information relevant to operating or maintaining the lifting device 10. The tool usage information, such as current levels, motor speed, motor acceleration, motor direction, lift height, etc., may be captured or inferred from data output by the sensors 640. Such power tool information may then be accessed by a user with an external device (e.g., remote control unit 140, a cellphone, an external device 700 [sce FIG. 27], etc.). In other constructions, the controller 625 includes additional, fewer, or different components.

The wireless communication controller 630 is coupled to the controller 625. In the illustrated embodiment, the wireless communication controller 630 is located in electronics housing 86 (see FIG. 1) to save space and ensure that the magnetic activity of the motor 90 does not affect the wireless communication between the lifting device and the external device.

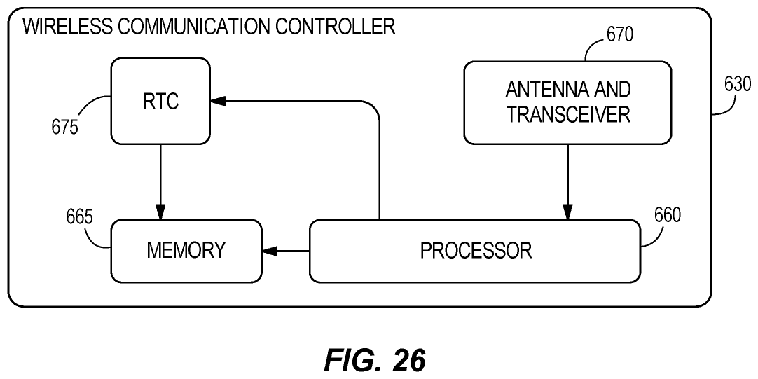

FIG. 26 illustrates the wireless communication controller 630 for the lifting device 10. The wireless communication controller 630 includes a processor 660, a memory 665, an antenna and transceiver 670, and a real-time clock (RTC) 675. The wireless communication controller 625, 630 enables the lifting device 10 to communicate with an external device (see FIG. 27). The radio antenna and transceiver 670 operate together to send and receive wireless messages to and from the external device 700 and the processor 660. The memory 665 can store instructions to be implemented by the processor 660 and/or may store data related to communications between the lifting device 10 and the external device 700, or the like. The processor 660 for the wireless communication controller 630 controls wireless communications between the lifting device 10 and the external device 700. For example, the processor 660 associated with the wireless communication controller 630 buffers incoming and/or outgoing data communicates with the controller 625, and determines the communication protocol and/or communicates with the controller 625, and determines the communication protocol and/or settings to use in wireless communications. The communication via the wireless communication controller 630 can be encrypted to protect the data exchanged between the lifting device 10 and the external device 700 from third parties.

In the illustrated embodiment, the wireless communication controller 630 is a Bluetooth® controller. The Bluetooth® controller communicates with the external device 700 employing the Bluetooth® protocol. Therefore, in the illustrated embodiment, the external device 700 and the lifting device 10 are within a communication range (e.g., in proximity) of each other while they exchange data. In other embodiments, the wireless communication controller 630 communicates using other protocols (e.g., Wi-Fi, ZigBee, a proprietary protocol, etc.) over different types of wireless networks. For example, the wireless communication controller 630 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, 4GSM network, a 4G LTE network, 5G New Radio, a Digital AMPS (“IS-136/TDMA”) network, or an Integral Digital Enhanced Network (“iDEN”) network, etc.

The RTC 675 increments and keeps time independently of the other components. Having the RTC 675 as an independently powered clock (e.g., by coin cell battery) can enable, for example, time stamping of operational data (stored in memory 665 for later export).

FIG. 27 illustrates a communication system 705. The communication system 705 includes the lifting device 10, the remote control unit 140, and the external device 700. The communication system 705 may include a plurality of lifting devices 10 and a plurality of external devices 700. Each lifting device 10 and external device 700 can communicate wirelessly while they are within a communication range of each other. Each lifting device 10 may communicate status, operation statistics, identification, sensor data, usage information, maintenance data, and the like.

Using the external device 700, a user can access operational parameters of the lifting device 10. For example, the user may receive sensor information about the connected battery pack (e.g., voltage, charge, etc.) to determine when to remove the battery pack for charging. The external device 700 can also transmit data to the wireless communication controller 630 for charger configuration, firmware updates, to send commands, etc. The external device 700 also allows a user to set operational parameters (e.g., lift height, etc.), safety parameters, security parameters, select other operational modes, and the like for lifting device 10.

The external device 700 is for example, a smart phone (as illustrated), a laptop computer, a tablet computer, a personal digital assistant (PDA), or another electronic device capable of communication wirelessly with the lifting device 10. The external device 700 provides a user interface and allows a user to access and interact with the lifting device 10. enable or disable features, and the like. The user interface of the external device 700 provides an easy-to-use interface for the user to control and customize operation of the lifting device 10. The external device 700, therefore, grants the user access to the operational data of the lifting device 10 and provides a user interface such that the user can interact with the wireless communication controller 630.

In addition, with continued reference to FIG. 27, the external device 700 can also share operational data obtained from the lifting device 10 with a remote server 710 connected through a network 715. The remote server 710 may be used to store the operational data obtained from the external device 700, provide additional functionality and service to the user, or a combination thereof. In some embodiments, storing the information on the remote server 710 allows a user to access the information from a plurality of different locations. In some embodiments, the remote server 710 collects information from various users regarding their devices and provide statistics or statistical measures to the user based on information obtained from the different devices. Conversely, the remote server 710 may also be used to send programmable operations and firmware updates to the lifting device 10. The network 715 may include various networking elements (routers 720, hubs, switches, cellular towers 725, wired connections, wireless connections, etc.) for connecting to, for example, the Internet, a cellular data network, a local network, or a combination thereof as previously described.

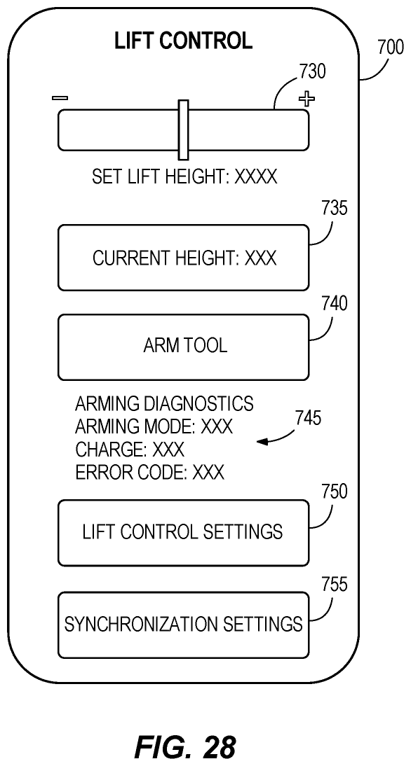

FIG. 28 illustrates an exemplary interface of the external device 700 for controlling the lifting device 10. In the interface of the illustrated embodiment, the user is able to adjust the operating height of the lifting device 10 using a lift height slider 730. The user may also receive feedback about the height of the lift based on a height indicator 735. The user may further control the operative mode of the lifting device 10 using an arming button 740 and receive feedback about the arming mode based on an arming diagnostics table 745. Arming will be further discussed below. The interface may also incorporate programable controls such as a lift control settings button 750 and a synchronization settings button 755. The lift control settings button 750 may allow a user to customize and adjust various operational parameters of the lifting device 10 (e.g., motor speed, output torque, start height, end height, etc.). The synchronization settings button may allow the lifting device 10 to connect to other lifting devices within the network 715 to coordinate programable actions. For example, another lifting device could be set to mirror the actions of the lifting device 10. Alternatively, the other lifting device could be programed to operate after the lifting device 10 finishes an operation.

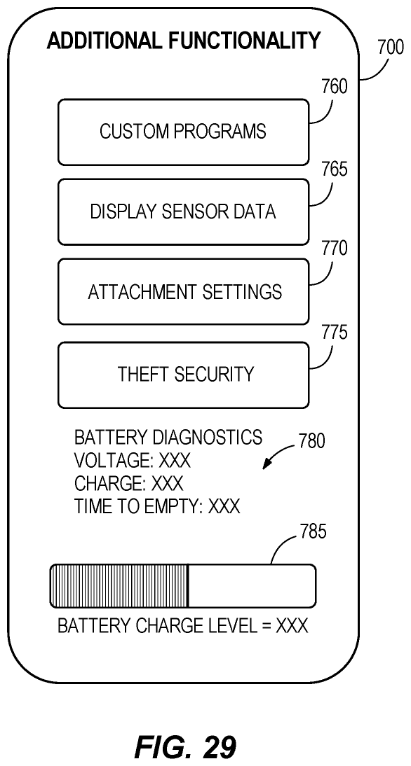

As shown in FIG. 29, the interface of the external device 700 may increase the functionality of the lifting device 10 by incorporating and controlling additional software features. For example, a user may be able to apply custom programs using a custom program interface 760 and adjust settings based on accessory attachments attached to the lifting device using an attachment interface 770. The user may additionally use the external device to view internal operational data not displayed on the user interface (e.g., motor temperature) using a sensor data interface 765, or view battery diagnostics using a battery diagnostics table 780 and battery charge bar 785. In addition, the user can use to external device 700 to implement programmable security protocols using a security interface 775.

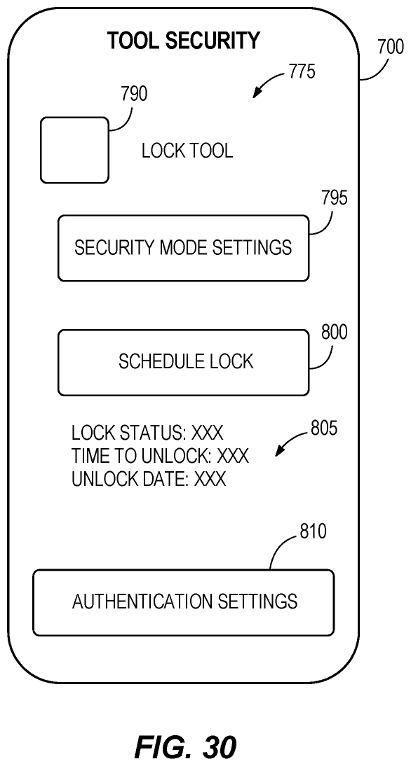

With reference to FIG. 30, the security interface 775 of the external device 700 can be used to remotely enable or disable the lifting device using a lock button 790. The security interface 775 may further allow the user to customize the time the device is locked using a settings button 795 and schedule a lock for a specific time and/or date using a schedule lock button 800. The user may use the security interface 775 to view the current security state (e.g., the lock status, the time to unlock, etc.) using a lock indicator 805. In some embodiments, the lifting device 10 displays an indication of the locked status using, for example, one or more visual indicators (e.g., one or more LEDs) on the lifting device 10. In some embodiment, when the lifting device 10 is locked, any controls associated with the lifting device can be disabled. Furthermore, the user may use the security interface 775 to customize the use and type of authentication using an authentication settings button 810. For example, in some embodiments, to unlock a tool, a user must enter a password in the external device 700. The external device 700 may also be used to track the lifting device 10 if the lifting device is stolen or goes missing.

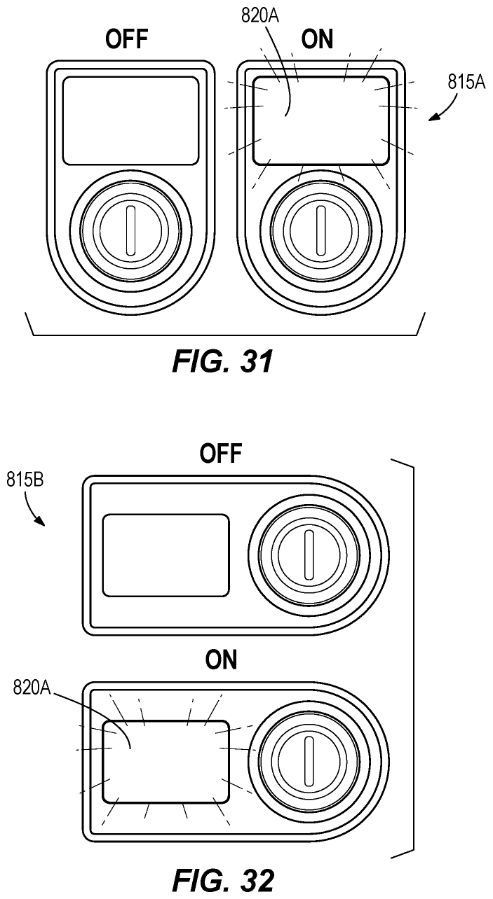

FIGS. 31 and 32 illustrate embodiments of an arming button 815a, 815b, respectively. The arming button 815a, 815b is used to control the operational mode of the lifting device 10, and may be disposed on the lifting device 10, and/or may be usable through an external device 700 or remote control unit 140. The arming button 815a, 815b includes a light indicator 820a, 820b (e.g., at least one LED) to notify the user of an arming state representing the operational mode of the lifting device 10. In the illustrated embodiments, the arming button 815a, 815b allows the user to alternate the lifting device between, for example, a “live” state, an “idle” state, and a “off” based on the duration of time the arming button 815a, 815b is pressed. The lifting device 10 may alternate operational states to conserve power. For example, the lifting device 10 may move from the “live” state to the “idle” state if the lifting device 10 has not received an input after a time period. Additionally, the lifting device may move from the “idle” state to the “off”′ state if the lifting device remains in the “idle” state for a second time period.

In some embodiments, pressing the arming button 815a, 815b causes the lifting device to power on (e.g., when pressed and held for one second). The lifting device may be disabled until the arming button 815a, 815b is pressed. In some embodiments, the light indicators 820a, 820b gradually ramp up in intensity while the lifting device 10 is arming (e.g., for one second). The lifting device 10 may not be operational until the light indicators 820a, 820b are fully illuminated. Once the light indicators 820a, 820b are fully illuminated (e.g., solid white), the lifting device 10 can be used. If the lifting device 10 is unused or idle for a period of time (e.g., 30 minutes), the light indicators 820a, 820b can turn off and the lifting device 10 is no longer armed and ready for use. The lifting device 10 can be turned off by, for example, pressing and holding the arming button 815a, 815b for a period of time (e.g., two seconds).

The light indicator 820a, 820b may have an illumination corresponding with the device state. For example, at an “idle” state, the LED may flash or have a reduced brightness. In some embodiments, the LED may increase in brightness after the lifting device 10 is turned on to indicate when the lifting device 10 is ready to be used.

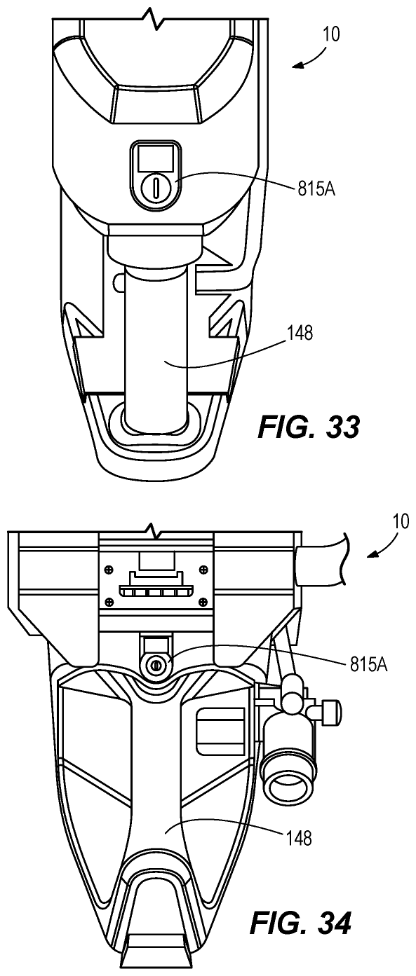

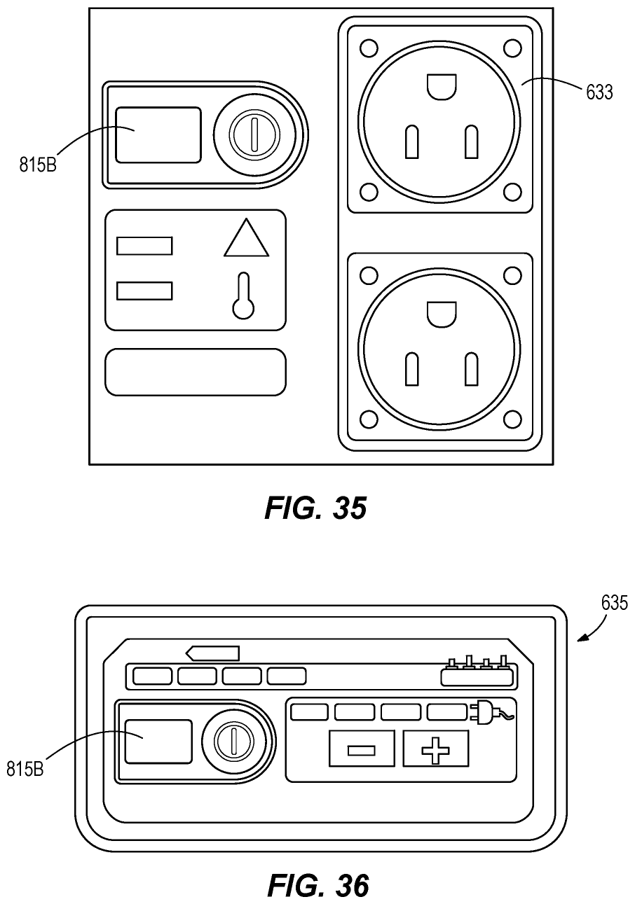

As shown in FIGS. 33 and 34, the arming button 815a (or 815b) may be disposed near a handle 148 of the lifting device 10 for easy access by a user. In another embodiment shown in FIG. 35, the arming button 815b (or 815a) may be disposed near the AC input port of the AC power input 633. As exemplified in FIG. 36, the arming button 815 may also be accessible on the user interface 635 of the lifting device 10. In some embodiments, there may be multiple arming buttons located in a plurality of locations on the lifting device 10 and the interface of the external device 700.

Although the invention has been described in detail with reference to certain preferred embodiments, variations and modifications exist within the scope and spirit of one or more independent aspects of the invention as described.

Various features of the invention are set forth in the following claims.

1. A lifting device comprising:
a base;
a mast coupled to the base;
a carriage coupled to the mast;
a lifting assembly configured to move the mast and the carriage in a first direction to a desired elevation relative to the base, the lifting assembly including an electric motor, a battery pack for providing electrical power to the electric motor, and a first spool with a first cable to alternately raise and lower the carriage in the first direction; and
an auxiliary drive unit including a second spool with a second cable to raise and lower the lifting device in a second direction different than the first direction.

2. The lifting device of claim 1, wherein the auxiliary drive unit is electrically coupled to the electric motor to alternately raise and lower the lifting device in the second direction relative to a grounded position.

3. The lifting device of claim 1, wherein the electric motor provides torque to the first spool to alternately raise and lower the carriage in the first direction, and wherein the electric motor provides torque to the second spool to alternately wind and unwind the second cable from the second spool.

4. The lifting device of claim 1, wherein the electric motor provides torque to both the first spool and the second spool in a first configuration, and wherein the electric motor provides torque to only the second spool in a second configuration.

5. The lifting device of claim 1, wherein the auxiliary drive unit is removably coupled to the electric motor.

6. The lifting device of claim 1, wherein the auxiliary drive unit is removably coupled to the first spool.

7. The lifting device of claim 6, wherein the auxiliary drive unit includes a shaft coupling the auxiliary drive unit to the first spool.

8. The lifting device of claim 1, wherein the second spool includes a female feature, wherein the second cable includes an end having a male feature, and wherein the female feature is configured to receive the male feature to secure the second cable to the second spool.

9. The lifting device of claim 1, wherein the lifting device includes a selector configured to selectively operate the lifting device and the auxiliary drive unit.

10. The lifting device of claim 9, wherein the selector is a remote control unit in wireless communication with the lifting device.

11. A lifting system comprising:
a lifting device including
a base,
a mast coupled to the base,
a carriage coupled to the mast, and
a lifting assembly configured to move the mast and the carriage in a first direction to a desired elevation relative to the base, the lifting assembly including an electric motor and a battery pack for providing electrical power to the electric motor; and
a remote control unit in wireless communication with the lifting device and operable to alternately raise and lower the carriage in the first direction.

12. The lifting system of claim 11, wherein the remote control unit includes a first user control configured to activate the electric motor to move the mast and the carriage in the first direction, and a stop button operable to deactivate the electric motor.

13. The lifting system of claim 12, wherein the remote control unit includes a pistol grip.

14. The lifting system of claim 12, wherein the lifting device is a first lifting device, wherein the lifting system further includes a second lifting device including a second base, a second mast coupled to the second base, a second carriage coupled to the second mast, and a second lifting assembly configured to move the second mast and the second carriage to a desired elevation relative to the second base, wherein the second lifting assembly includes a second electric motor and a second battery pack for providing electrical power to the second electric motor, and wherein the remote control unit is in wireless communication with at least one of the first lifting device or the second lifting device.

15. The lifting system of claim 14, further comprising a second remote control unit in wireless communication with at least one of the first lifting device or the second lifting device.

16. The lifting system of claim 11, wherein the remote control unit includes a user interface operable to communicate information about the lifting device to an operator.

17. The lifting system of claim 16, wherein the lifting device includes a means of detecting a weight and/or a center of gravity of a load to be lifted by the lifting device.

18. The lifting system of claim 17, wherein the detecting means includes at least one sensor configured to detect the weight of the load to be lifted by the lifting device.

19. The lifting system of claim 17, wherein the detecting means includes at least one sensor configured to detect the center of gravity of the load to be lifted by the lifting device.

20. The lifting system of claim 19, wherein the lifting device includes a transceiver configured to receive instructions wirelessly from the remote control unit.

21-60. (canceled)
